(19) United States
(12) Patent Application Publication
(10) Pub. No.: US 2017/0010789 A1
(43) Pub. Date: Jan. 12, 2017

(54) EMPHASIS FOR SHARING APPLICATION PORTION

(71) Applicant: Microsoft Technology Licensing, LLC, Redmond, WA (US)

(72) Inventors: Vijay Mital, Kirkland, WA (US); Suraj T. Poozhiyil, Redmond, WA (US); Nizam Anuar, Snoqualmie, WA (US)

(21) Appl. No.: 14/794,747

(22) Filed: Jul. 8, 2015

(51) Int. Cl. G06F 3/0484; G06F 3/0481

(52) U.S. Cl. CPC G06F 3/04842; G06F 3/04817

(57) ABSTRACT

The rendering of information on an output device when there is a set of information rendered on the output device that is shareable to a second output device. In this context, shareable means that the application that generates the information is extracted and run instead on behalf of the second output device to render the information on the second output device. In addition, there is output an emphasis that aids the user in understanding that there is the technical capability to share the set of information in this manner. Thus, the user may be informed and more aptly initiate the technical ability to achieve the sharing of the set of information with the second output device.

### BACKGROUND

Computing technology has revolutionized the way we work, play, and communicate. Computing functional is obtained by a device or system executing software or firmware. The typical paradigm for application preparation is that the application is drafted well in advance of its use, and the functionality of the patent application is relatively predetermined.

There are some exceptions to the predetermined functionality. For instance, patches may be made to software application in order to provide repair of previously unknown bugs in the software. Furthermore, updates to software applications may be provided in order to add new functionality to the software application. In some cases, software may be configured and customized for a particular user. However, the application itself defines how far it can be customized. Users can also affect applications by providing commercial feedback on software performance. However, it can take years before user feedback is properly incorporated into an application.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

At least some embodiments described herein relate to the rendering of information on an output device when there is a set of information rendered on the output device that is shareable to a second output device. In this context, shareable means that the application that generates the information is extracted and run instead on behalf of the second output device to render the information on the second output device. In addition, there is output an emphasis that aids the user in understanding that there is the technical capability to share the set of information in this manner. Thus, the user may be informed and more aptly initiate the technical ability to achieve the sharing of the set of information with the second output device.

This Summary is not intended to identify key features or essential features of the claimed subject matter, nor is it intended to be used as an aid in determining the scope of the claimed subject matter.

### BRIEF DESCRIPTION OF THE DRAWINGS

In order to describe the manner in which the above-recited and other advantages and features can be obtained, a more particular description of various embodiments will be rendered by reference to the appended drawings. Understanding that these drawings depict only sample embodiments and are not therefore to be considered to be limiting of the scope of the invention, the embodiments will be described and explained with additional specificity and detail through the use of the accompanying drawings in which:

FIG. 1 symbolically illustrates a computing system in which some embodiments described herein may be employed.

FIG. 2 illustrates a flowchart of a method for rendering information on at least one output device of a computing system;

FIG. 3 illustrates a computing architecture that may be used to perform the method of FIG. 2;

FIG. 4 symbolically illustrates an example computerized rendering that may be created by the method of FIG. 2;

FIG. 5 illustrates a more concrete example of the rendering of FIG. 4;

FIG. 6 symbolically illustrates a simple transformation chain in which there is but a single link coupling a single data source and a single data target and in which a transformation represented by the link is automatically performed using a value in the data source as input to generate a value in the data target;

FIG. 7 symbolically illustrates another simple example transformation chain in which a transformation is performed using input values from three data sources in order to generate output values in two data targets;

FIG. 8 illustrates a transformation chain in the form of a combination of the transformation chain of FIG. 6 and the transformation chain of FIG. 7;

FIG. 9A through 9D each illustrate example transformation chains (arrows through which data does not flow absent joining with another transformation chain are illustrated with an “X”, and dependency elements that are not nodes in the transformation chain itself are illustrated with dashed lined borders);

FIG. 10A illustrates an augmented transformation chain representing the joining of the transformation chains of FIGS. 9A and 9B;

FIG. 10B illustrates an augmented transformation chain representing the joining of the transformation chains of FIGS. 9A and 9C;

FIG. 10C illustrates an augmented transformation chain representing the joining of the transformation chains of FIGS. 9B and 9C;

FIG. 10D illustrates an augmented transformation chain representing the joining of the transformation chains of FIGS. 9A and 9D;

FIG. 11A illustrates an augmented transformation chain representing the joining of the transformation chains of FIGS. 9A, 9B and 9C;

FIG. 11B illustrates an augmented transformation chain representing the joining of the transformation chains of FIGS. 9A, 9B and 9D;

FIG. 11C illustrates an augmented transformation chain representing the joining of the transformation chains of FIGS. 9A, 9C and 9D;

FIG. 12 illustrates an augmented transformation chain representing the joining of the transformation chains of FIGS. 9A, 9B, 9C and 9D;

FIG. 13 illustrates a node of a transformation chain along with numerous associated input endpoints and output endpoints;

FIG. 14 illustrates a runtime architecture in which transformation chains may be implemented, and which includes a canvas referred to herein as a universal canvas;

FIG. 15 illustrates a flowchart of a method for formulating an application in response to detecting events in an environment, which represents a simple case in which an instance of a transformation chain is created and operated within the universal canvas of FIG. 14;

FIG. 16 illustrates a flowchart of a method for responding to detecting events in the environment by combining transformation chain instances;

FIG. 17A illustrates a flowchart of a method for formulating an integrated instance of two transformation chain classes by first instantiating instances of each class, and then joining the instances;

FIG. 17B illustrates a flowchart of a method for formulating an integrated instance of two transformation chain classes by first combining the two transformation chain classes, and then instantiating from the combined transformation chain class;

FIG. 18A illustrates a transformation chain instance that is preparing to be split;

FIG. 18B illustrates a transformation chain instance that is split from the transformation chain instance of FIG. 18A;

FIG. 19 illustrates a flowchart of a method for formulating a split application;

FIGS. 20A through 20D illustrates various possible configurations for the split transformation chain instance of FIG. 18B;

FIG. 21 illustrates an architecture in which a larger transformation chain instance that is assigned to a first endpoint interface securely interfaces with a portion transformation chain instance that is assigned to a second endpoint interface via a proxy service;

FIG. 22 illustrates a flowchart of a method for sharing an application in response to detecting one or more events at a first endpoint interface entity; and

FIG. 23 illustrates a flowchart of a method for distributed interfacing with an application across a plurality of hardware entities.

### DETAILED DESCRIPTION

At least some embodiments described herein relate to the rendering of information on an output device when there is a set of information rendered on the output device that is shareable to a second output device. In this context, shareable means that the application that generates the information may be extracted and run instead on or on behalf of the second output device to render the information on the second output device. In addition, there is output an emphasis that aids the user in understanding that there is the technical capability to share the set of information in this manner. Thus, the user may be informed and more aptly initiate the technical ability to achieve the sharing of the set of information with the second output device.

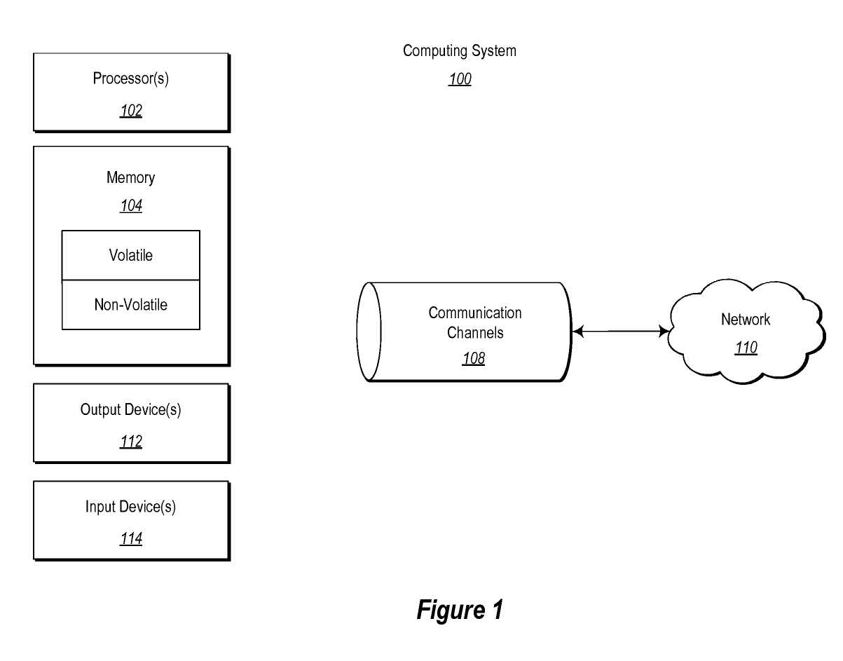

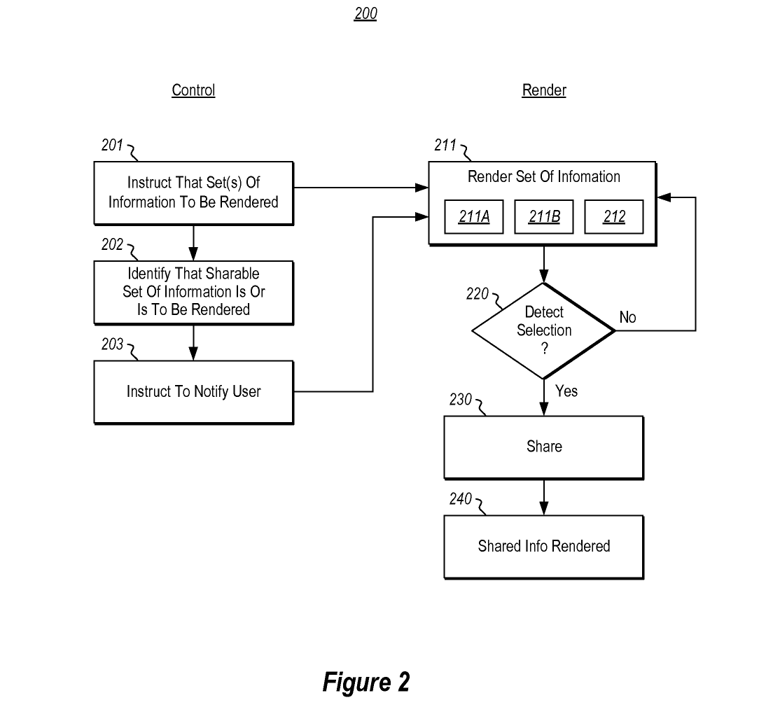

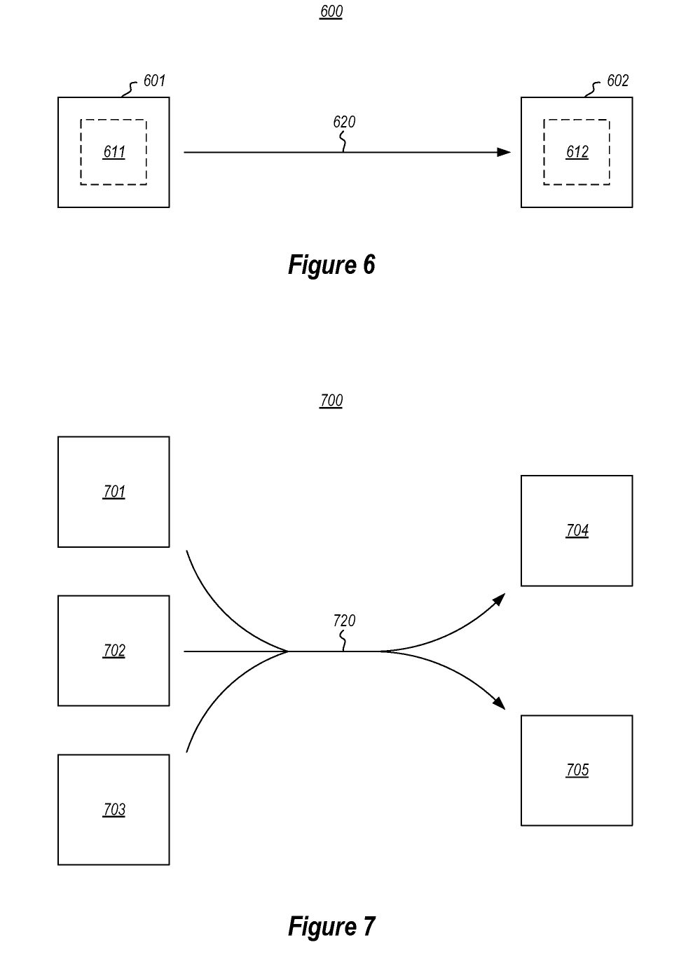

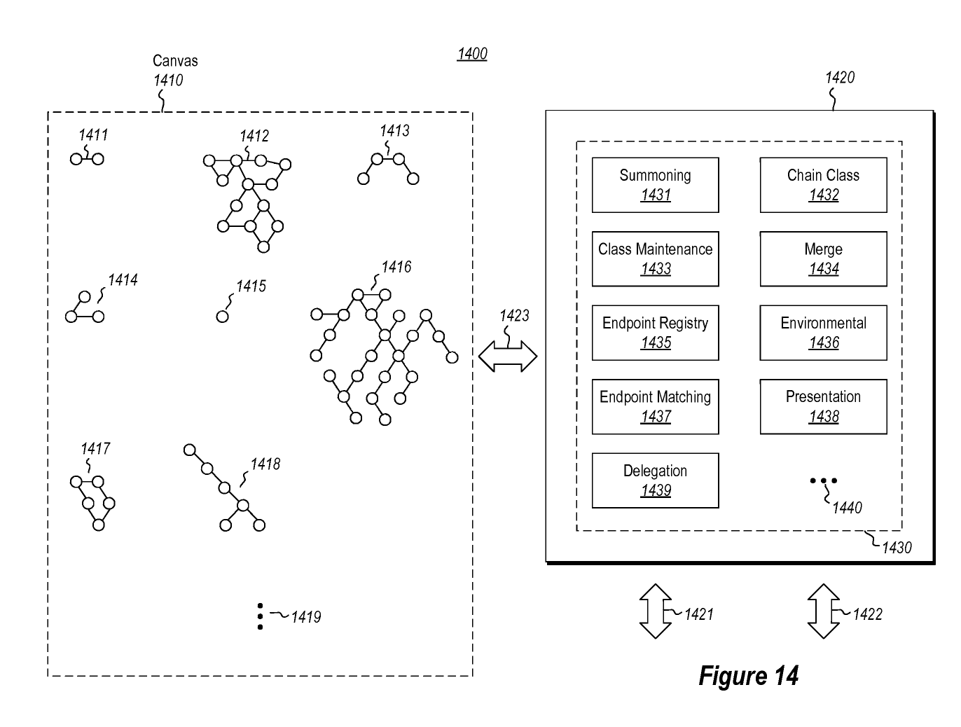

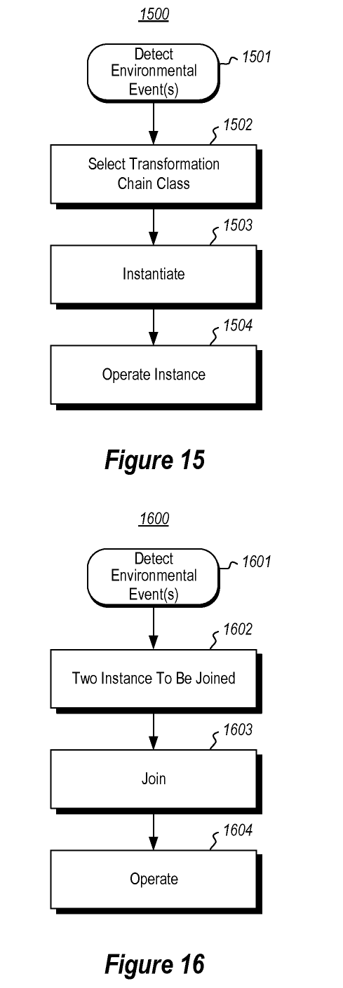

First, a computing system will be described with respect to FIG. 1. Then, the general principles of embodiments of outputting sets of shareable information, and the emphasis or notification to the user about the same will be described with respect to FIGS. 2 through 5. Thereafter, the concept of transformation chains will be described with respect to FIGS. 6 through 13. Then, an architecture for supporting a universe of transformation chains and their operation will be described with respect to FIG. 14. Thereafter, an example operation of transformation chains will be described with respect to FIGS. 15 through 23.

Computing System Description

Computing systems are now increasingly taking a wide variety of forms. Computing systems may, for example, be handheld devices, appliances, laptop computers, desktop computers, mainframes, distributed computing systems, or even devices that have not conventionally been considered a computing system. In this description and in the claims, the term “computing system” is defined broadly as including any device or system (or combination thereof) that includes at least one physical and tangible processor, and a physical and tangible memory capable of having thereon computer-executable instructions that may be executed by the processor. The memory may take any form and may depend on the nature and form of the computing system. A computing system may be distributed over a network environment and may include multiple constituent computing systems.

As illustrated in FIG. 1, in its most basic configuration, a computing system 100 typically includes at least one hardware processing unit 102 and memory 104. The memory 104 may be physical system memory, which may be volatile, non-volatile, or some combination of the two. The term “memory” may also be used herein to refer to non-volatile mass storage such as physical storage media. If the computing system is distributed, the processing, memory and/or storage capability may be distributed as well. As used herein, the term “executable module” or “executable component” can refer to software objects, routings, or methods that may be executed on the computing system. The different components, modules, engines, and services described herein may be implemented as objects or processes that execute on the computing system (e.g., as separate threads).

In the description that follows, embodiments are described with reference to acts that are performed by one or more computing systems. If such acts are implemented in software, one or more processors of the associated computing system that performs the act direct the operation of the computing system in response to having executed computer-executable instructions. For example, such computer-executable instructions may be embodied on one or more computer-readable media that form a computer program product. An example of such an operation involves the manipulation of data. The computer-executable instructions (and the manipulated data) may be stored in the memory 104 of the computing system 100. Computing system 100 may also contain communication channels 108 that allow the computing system 100 to communicate with other message processors over, for example, network 110.

The computing system 100 also may potentially include one or more output devices, such as output device(s) 112. Output devices may be any device that can render information. Examples of output devices include displays, speakers, lights, actuators, projectors, drones, or the like. The computing system 100 may also include one or more input devices, such as input device(s) 114. Examples of input devices include keyboards, pointer device (such as a mouse or tracking pad), voice recognition devices, touch screens, vision sensors, and possibly also physical sensors (e.g., thermometers, global positioning systems, light detectors, compasses, accelerometers, and so forth).

Embodiments described herein may comprise or utilize a special purpose or general purpose computer including computer hardware, such as, for example, one or more processors and system memory, as discussed in greater detail below. Embodiments described herein also include physical and other computer-readable media for carrying or storing computer-executable instructions and/or data structures. Such computer-readable media can be any available media that can be accessed by a general purpose or special purpose computer system. Computer-readable media that store computer-executable instructions are physical storage media. Computer-readable media that carry computer-executable instructions are transmission media. Thus, by way of example, and not limitation, embodiments of the invention can comprise at least two distinctly different kinds of computer-readable media: computer storage media and transmission media.

Computer storage media includes RAM, ROM, EEPROM, CD-ROM or other optical disk storage, magnetic disk storage or other magnetic storage devices, or any other storage medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to computer storage media (or vice versa). For example, computer-executable instructions or data structures received over a network or data link can be buffered in RAM within a network interface module (e.g., a “NIC”), and then eventually transferred to computer system RAM and/or to less volatile computer storage media at a computer system. Thus, it should be understood that computer storage media can be included in computer system components that also (or even primarily) utilize transmission media.

Computer-executable instructions comprise, for example, instructions and data which, when executed at a processor, cause a general purpose computer, special purpose computer, or special purpose processing device to perform a certain function or group of functions. The computer executable instructions may be, for example, binaries or even instructions that undergo some translation (such as compilation) before direct execution by the processors, such as intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

User Interface Example

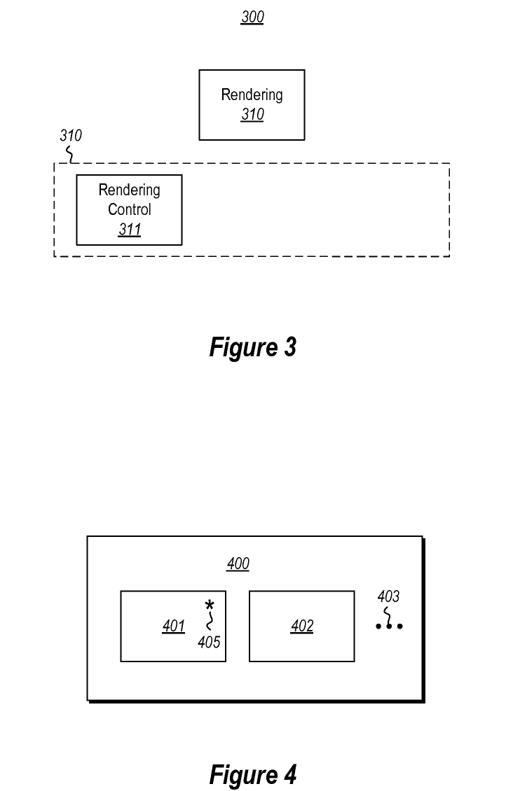

FIG. 2 illustrates a flowchart of a method 200 for rendering information on at least one output device of a computing system. As an example, the computing system may be the computing system 100 of FIG. 1, and the output device may be the output device 112 of FIG. 1. FIG. 3 illustrates a computing architecture 300 that may be used to perform the method 200. The computing architecture 300 includes control components 310 and a rendering component 320. In FIG. 2, those acts that are performed by one or more of the control components 310 are illustrated in the left column of FIG. 2 under the heading “Control”; and those acts that are performed by the rendering component 320 are illustrated in the right column of FIG. 2 under the heading “Render”.

The control component(s) first instruct (or cause) one or more sets of information to be rendered on an output device of the computing system (act 201). For instance, the rendering control component 311 may provide this instruction. In response, the rendering component 320 renders the sets of information to be rendered on the output device (act 211). For instance, FIG. 4 symbolically illustrates an example computerized rendering 400 that may be created by this process. The computerized rendering includes a first set 401 of information and a second set 402 of information, amongst potentially other sets of information as represented by the ellipses 403. In that case, the rendering (act 211) includes an act of rendering the first set 401 (act 211A) and an act of rendering the second set 402 (act 211B).

In this embodiment, the first set 401 of information is shareable, and the second set 402 of information is not shareable. The shareable set of information is shareable in that one or more application portions that generated the shareable set of information 401 may be extracted and operated for rendering of the shareable set of information at a second output device. An example on how this may be accomplished will be described further below with respect to FIGS. 6 through 23. The non-shareable set 402 of information, on the other hand, is not shareable in this way.

Before or after the first set 401 of information is rendered (act 211A), the control components 310 (e.g., perhaps rendering control component 311) identifies that a shareable set of information is being or is to be rendered on the output device (act 202). Accordingly, the control components 310 (e.g., again perhaps the rendering control component 311) instructs the rendering component 320 to notify the user that the shareable set of information is shareable (act 203). In response, the rendering component 320 emphasizes (act 212) that the shareable set of information is shareable so as to communicate to a user a technical readiness to receive and implement an instruction to share the shareable set of information to the second output device. Furthermore, the rendering may be made in such a way as to distinguish those sets of information that are shareable from those sets of information that are not shareable. In FIG. 4, this emphasis that provides the user such notification of sharability is represented by the set of information having the asterisk 405, whereas the second set 402 of information has no asterisk.

The output of the emphasis may, but need not, be performed on the same output device on which the rendering is made. Furthermore, the emphasis may be output automatically or in response to one or more environmental events. For instance, perhaps the output is emphasized in response to user selection input being received that is associated with the shareable set of information.

There are a variety of sensory forms that the rendering 400 may take. For instance, the rendering 400 may be visual rendering, in which case the output device would be a display, projector, holographic imager, or the like. The rendering may be an audio rendering, in which case the output device might be a speaker. The rendering may be tactile, in which case, the output device may provide tactile renderings (actuators such as brail displays). The output of the emphasis may take on the same or different sensory form as compared to the rendered information. For instance, if the rendered information is visual information on a display, the emphasis may be some visualized emphasis on that display (in the case of the sensory form being the same), or some auditory emphasis (in the case of the sensory form being different).

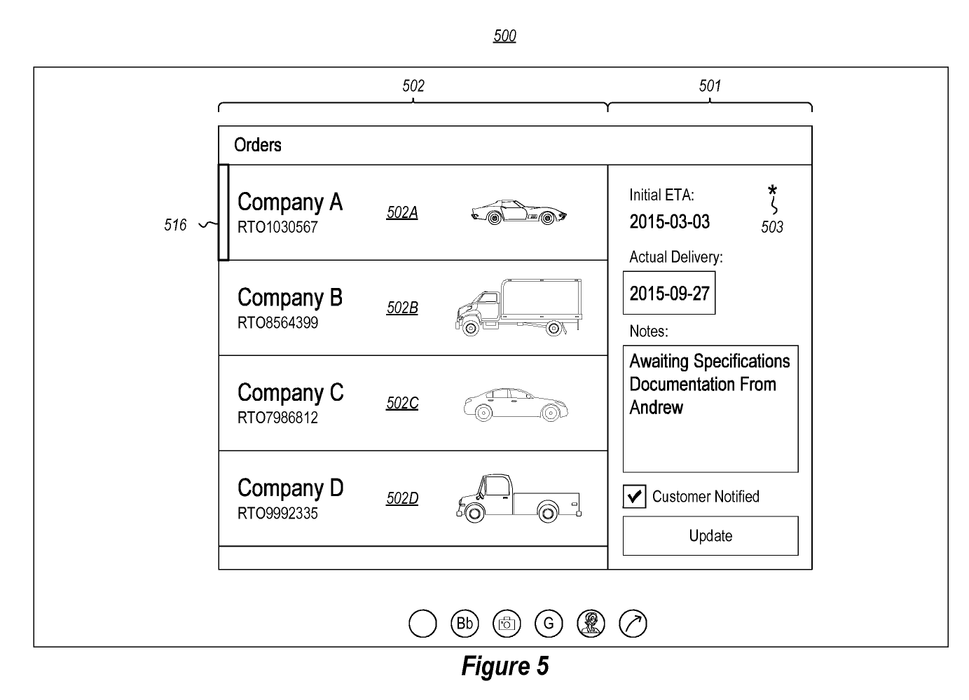

FIG. 5 illustrates a more concrete example of the rendering 400 of FIG. 4. In the case of FIG. 5, the rendering 400 is a visual rendering. Accordingly, FIG. 5 illustrates a visualized user interface 500. The user interface 500 is illustrated in state in an object summary set 502 of information and an object details set 501 of information are both displayed. The object summary set 502 includes an enumeration of four order fields 502A through 502D. Each order field includes a name of the order, a picture of the item ordered, and a purchase order number. The user may select the order field 502A (as represented by the thick vertical bar 516) causing the object details set 501 to appear. In one embodiment, this is accomplished by expansion of the application itself upon detecting that the user selected the order field 502A. More regarding this dynamic building of applications in response to environmental events will be described below with respect to FIG. 6.

Suppose that the object summary set 502 of information is not shareable, but the object details set 501 is shareable. For instance, perhaps the user is communicating with a supplier of the product detailed in the object details set 501 which corresponds to the selected order field 502A. The user may not want the supplier to have a view on what other orders have been placed, or what other products are being considered for purchase. The sharability of the object details set 501 of information is represented by the asterisk 503, whereas the object summary set 502 of information has no asterisk.

Here, the object details set 501 of information represents an example of the first set 401 of information of FIG. 4; and the object summary set 502 of information represents an example of the second set 402 of information of FIG. 4. Furthermore, the display of the object details set 501 of information represents an example of the act 211A of FIG. 2; and the display of the object summary set 502 of information represents an example of the act 211B of FIG. 2.

In the case of the rendered information being displayed information, and the output of emphasis occurring in the same sensory form (visually), and on the same output device (e.g., the same display), there are a variety of examples of how to emphasize that a set of information is shareable. For instance, the color of at least a portion of the shareable set of information may be altered, or the color of an object associated with the shareable set of information may be altered, in a manner that is different than would be the color if the shareable set of information were not shareable. For example, the shareable information or its container may be colored to provide high contrast with the remaining sets of information that are not shareable.

Alternatively or in addition, a grouping of at least a portion of the shareable set of information may be altered so as to be different than would be the grouping if the shareable set of information were not shareable. For instance, sets of shareable information may be grouped or positioned with other sets of shareable information, with perhaps some separation from other sets that are not shareable.

Alternatively or in addition, a positioning of at least a portion of the shareable set of information may be altered so as to be different than would be the positioning if the shareable set of information were not shareable. For instance, shareable sets of information may be placed in a predetermined and/or configurable portion of the display.

Alternatively or in addition, a focus of at least a portion of the shareable set of information may be altered to as to be different than would be the focus if the shareable set of information were not shareable. For instance, shareable sets of information may be provided in slightly larger font, in a larger window, or perhaps may be in focus (whereas non-shareable sets may be slightly blurred—at least temporarily).

Alternatively or in addition, a layering of at least a portion of the shareable set of information may be altered so as to be different than would be the layering if the shareable set of information were not shareable. For instance, windows that include shareable sets of information may be provided more in the foreground that those windows that contain non-shareable sets of information.

In some case, the outputting of emphasis (act 212) may occur in response to user selection input associated with the shareable set of information being received. For instance, the user selection input might be a substantial circling of the displayed shareable set of information. If the user were to, for instance, circle the order details set 501 of information in FIG. 5, then perhaps only then might the visual emphasis be provided. If the user were to, for instance, circle both the order details set 501 of information and the order summary set 502 of information, then perhaps then visual emphasis of the order details set 501 may then be manifested.

Referring back to FIG. 2, given this additional assistance to the user regarding what sets of information are shareable and what sets of information are not shareable, the user may then provide a more intelligent user input gesture selecting a set of information to share, and selecting the target for sharing. Accordingly, the method 200 also includes detecting (decision block 220) a portion selection user interaction that is indicative of selection of the shareable set of information. Furthermore, in response to the detection of such user input (“Yes” in decision block 220), the portion of the application that generated the output is extracted and run on behalf of or on the second output device (act 230), causing rendering of the shareable set of information to be rendered on the second output device (240).

The Transformation Chain Application

An example implementation in which portions of applications may be moved from one output device to another occurs in the context of the application itself being a transformation chain. A transformation chain is an interconnected set of nodes that each may represent data sources and/or data targets. There are links between the nodes, each link representing a transformation. For any given link, the associated transformation receives copies of values of one or more data sources situated at an input end to the link, and generates and provides resulting values at one or more data targets located at the output end of the link. For any given transformation, when a value at one or more of the data sources at its input end changes, the transformation is automatically reevaluated, potentially resulting in changes in value(s) of one or more data targets at the output end of the transformation.

In one embodiment, regardless of how complex the transformation chain is, the transformations may be constructed from declarative statements expressing equations, rules, constraints, simulations, or any other transformation type that may receive one or more values as input and provide resulting one or more values as output. An example of a transformation chain is a spreadsheet program, where any of the cells can be a data source or a data target. An equation (i.e., a transformation) may be associated with any cell to cause that cell to be a data target where results of the equation are placed.

As an example only, FIG. 6 illustrates a simple transformation chain 600 in which there is but a single link 620. In the drawing notation used throughout this description, a link will be illustrated as an arrow, with the input end being represented as the tail of the arrow, and the output end being represented as the head of the arrow. In cases in which there are multiple data sources at the input end of the link, the arrow will be represented with multiple tails. Copies of the values of the data source(s) at the tail(s) of the arrow represent input to the transformation. In cases in which there are multiple data targets affected by resulting value(s) of the transformation, the arrow will be represented with multiple heads. The values of the data target(s) at the head(s) of the arrow represent output from the transformation.

For instance, FIG. 6 illustrates a simple transformation chain 600 that includes a data source 601, a data target 602, and a single link 620. The link 620 represents a transformation performed on a copy of the value 611 at the data source 601 in order to generate a value 612 at the data target 602. Should the value 611 change, the transformation represented by link 620 is automatically reevaluated potentially resulting in a change in the value 612 in the data target 602.

FIG. 7 illustrates another simple example transformation chain 700 that includes three data sources 701, 702 and 703; two data targets 704 and 705, and a single link 720. The link 720 represents a transformation performed on copies of the values within the data sources 701, 702 and 703, in order to generate the values in the data targets 704 and 705. Should any of the values within the data sources 701, 702 or 703 change, the transformation link 720 is automatically reevaluated potentially resulting in a change in the values within any one or more of the data targets 704 and 705.

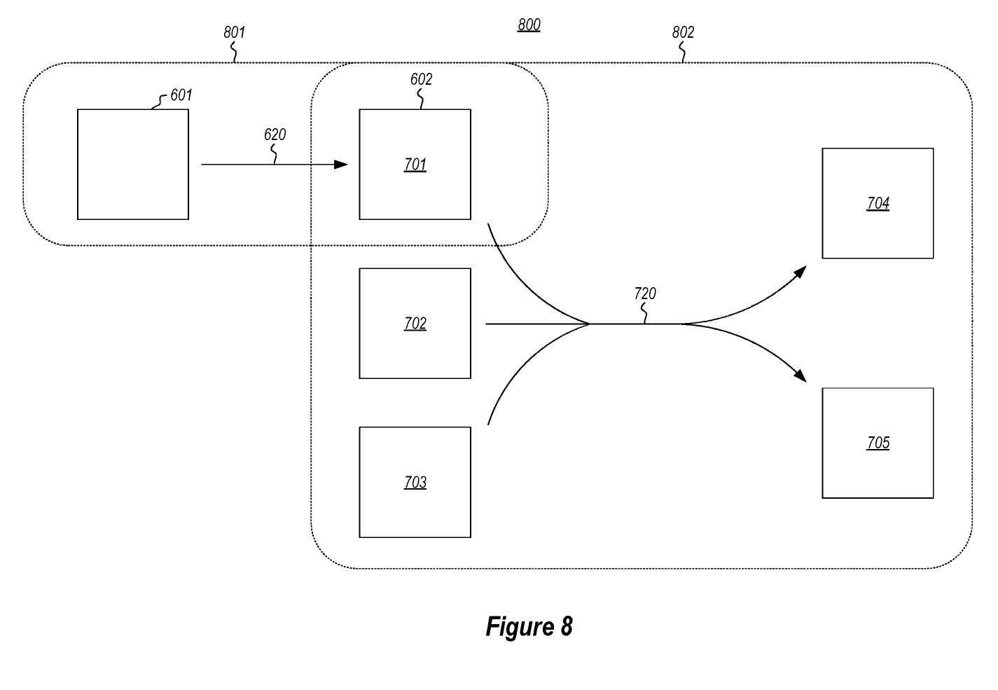

FIG. 8 illustrates another example transformation chain 800, and illustrates the principle that transformation chains may build on each other in which a data source to one link may be a data target in other link, in order to create even more complicated transformation chains. For instance, the transformation chain 800 includes an instance 801 of the transformation chain 600, and an instance of 802 of the transformation chain 700. In this case, the data target 602 of the link 620 is also a data source 701 of the link 720. Should the value with the data source 601 change, the transformation represented by link 620 is reevaluated potentially resulting in a change in the value in the data target 602, which is likewise a data source 701 for the next link 720. Likewise, a change in a value of data source 701 would result in the transformation link 720 being reevaluated potentially resulting in a change in the values within any one or more of the data targets 704 and 705. Thus, a change in the value at data source 601 has the potential, through transformation reevaluation, to affect value(s) at node 602 (701) and at nodes 704 and 705. Data targets 704 and 705 might likewise represent data sources for yet other links. Accordingly, in complex transformation chains, a value change might cause propagated value changes through multiple nodes in a transformation chain through proper automated reevaluation of transformations within the transformation chain.

While the example transformation chain 800 includes just two links, transformation chains may be quite complex and involve enumerable nodes and associated links connecting those enumerable nodes. The principles described herein may operate regardless of the complexity of the transformation chains.

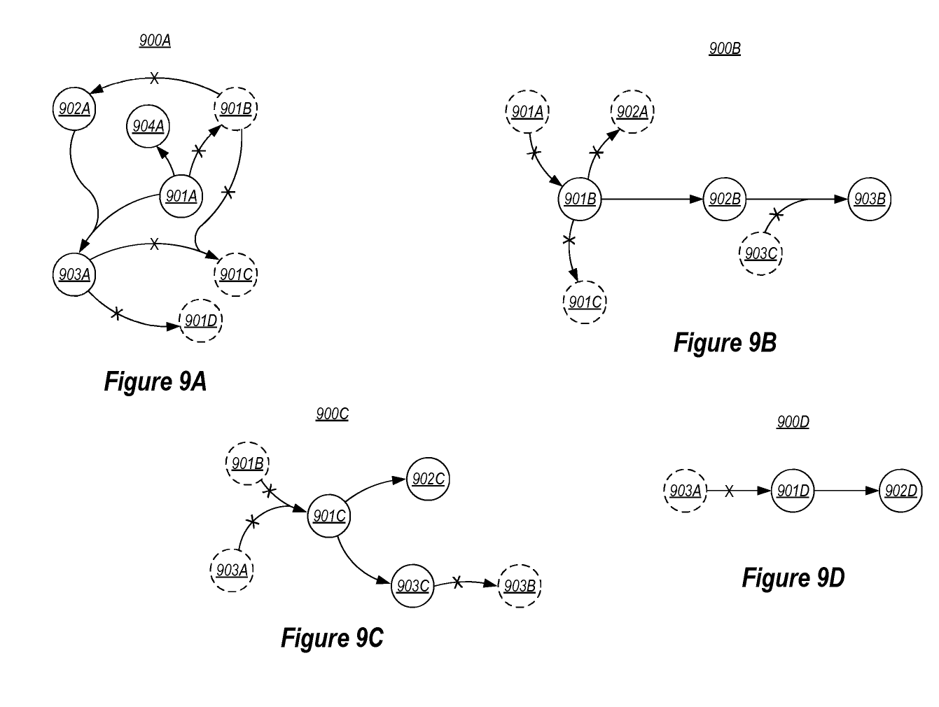

FIG. 9A through 9D illustrates example transformation chains instances or classes 900A through 900D. The instances will have the same structure as the classes, and so the illustrated forms may be considered to represent transformation classes as well as transformation instances. Instances will, however, have particular instance state associated with each of one or more of the nodes of the transformation chain. Accordingly, elements 900A through 900D may be referred to as transformation chain classes or transformation chain instances. The term “transformation chain” will be used to generally refer to both transformation chain classes and their associated transformation chain instances.

The example transformation chains 900A through 900D are relatively simple in order to avoid obscuring the broader principles described herein with an overly complex example. That said, the principles described herein apply regardless of how complex the transformation chain, and regardless of the number of transformation chains and associated devices that are within the environment and forming the compound application.

In the notation of FIGS. 9A through 9D, the nodes that belong to the transformation class 900N (where N ranges from A through D) are represented using the suffix N. For instance, in FIG. 9A, the transformation chain 900A includes nodes 901A, 902A, 903A, and 904A. The remaining elements 901B, 901C and 901D do not end with the “A” suffix, and thus are not nodes within the transformation chain 900A. Instead, the elements 901B, 901C and 901D represent dependencies with other transformation chains.

Throughout FIGS. 9A through 9D, 10A through 10D, 11A through 11C, and 12, to emphasize those elements that are dependency elements, rather than nodes in the transformation chain itself, dependency elements are represented with dashed-lined boundaries. Data does not flow from a node to a dependency element unless the transformation chain is joined with another transformation chain that includes a node represented by the dependency element. The fact that data cannot flow along a particular transformation is represented throughout the figures by the link being marked with an “X”.

For instance, element 901B in transformation chain 900A represents a dependency with node 901B in the transformation chain 900B. The dependency element 901B is bordered with dashed lines, and all links leading to or from that dependency element 901B are marked with an “X” since at this stage, the transformation chain 900A is not joined with the transformation chain 900B. Element 901C in transformation chain 900A represents a dependency with node 901C in transformation chain 900C. Element 901D in transformation chain 900A represents a dependency with node 901D in transformation chain class 900D.

On its own, the transformation chain instance 900A can function as an application. For example, a copy of a value or copies of values from data source 901A may be used to form a transformed result as a value or values of data target 904A. Furthermore, a copy of a value or copies of values from data sources 901A and 902A may be transformed to result in a value or values of data target 903A. If the transformation chain instance 900A is on its own, the transformations leading to and from the elements 901B, 901C and 901D are not evaluated.

The transformation chain 900B includes three nodes 901B, 902B and 903B. However, the transformation chain 900B also includes dependency elements 901A, 902A, 901C and 903C that reference a node in a different transformation chain. Again, the transformation chain instance 900B may operate independently as a single application. For example, a copy of a value or copies of values from data source 901B may be provided through a transformation to generate a resulting value or values for data target 902B. A copy of a value or copies of values from the data source 902B may be provided through a transformation to generate a resulting value or values for data target 903B.

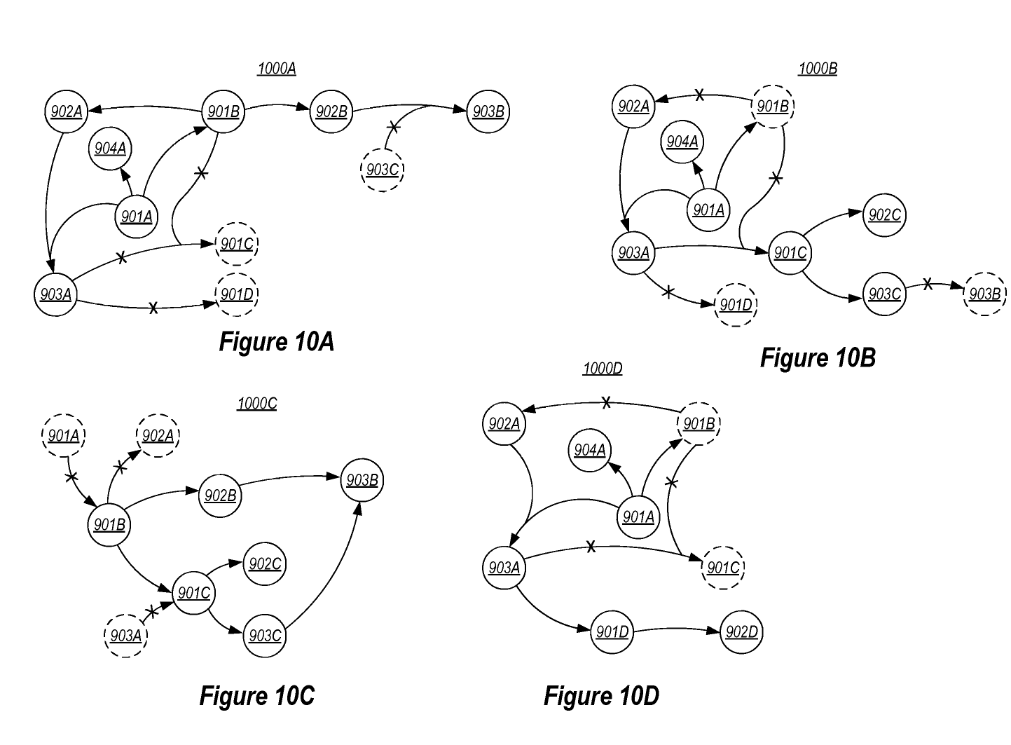

Though the transformation chain instances 900A and 900B may operate independently, FIG. 10A illustrates a joined transformation chain 1000A that includes transformation chain 900A joined with transformation chain 900B. Where appropriate, dependency elements in each of the transformation chains are now replaced with the actual node referred to. For example, dependency element 901B of FIG. 9A is now node 901B in FIG. 10A, and dependency elements 901A and 902A of FIG. 9B are now nodes 901A and 902A, respectively, in FIG. 10A. Thus, all of the nodes that have the suffix A or B are nodes within the transformation chain 1000A, and only those nodes that have suffixes C or D are dependency elements. For example, nodes 901A, 902A, 903A, 904A, 901B, 902B and 903B are nodes within the augmented transformation chain 1000A, and the functionality of the compound application becomes somewhat better, more complete, or at least different than the sum of the functionality of the individual transformation chains 900A and 900B on their own.

The transformation chain 900C includes three nodes 901C, 902C and 903C. However, the transformation chain 900C also includes dependency elements 903A, 901B and 903B that reference a node in a different transformation chain. Again, the transformation chain instance 900C may operate independently as a single application. For example, a copy of a value or copies of values from data source 901C may be provided through a transformation to generate a resulting value or values for data target 902C. Likewise, a copy of a value or copies of values from the data source 901C may also be provided through a transformation to generate a resulting value or values for data target 903C.

Though transformation chain instances 900A and 900C may operate independently, FIG. 10B illustrates a joined transformation chain 1000B that includes transformation chain 900A joined with transformation chain 900C. Dependency elements in each of the transformation chains are now replaced with the actual node referred to the extent that the dependency element refers to a node within any of transformation chains 900A or 900C. Now all of the nodes that have the suffix A or C are nodes within the transformation chain, and only those nodes that have suffixes B or D are dependency elements. For example, nodes 901A, 902A, 903A, 904A, 901C, 902C and 903C are nodes within the augmented transformation chain 1000B. The functionality of the compound application becomes better, more complex, or at least different than the sum of the functionalities of the individual transformation chain instances 900A and 900C.

FIG. 10C illustrates a joined transformation chain 1000C that includes transformation chain class 900B joined with transformation chain class 900C. Dependency elements in each of the transformation chains are replaced with the actual node referred to the extent that the dependency element refers to a node within any of transformation chains 900B or 900C. Now all of the nodes that have the suffix B or C are nodes within the transformation chain, and only those nodes that have suffixes A or D are dependency elements. For instance, nodes 901B, 902B, 903B, 901C, 902C and 903C are nodes within the augmented transformation chain 1000C, and the functionality of the compound application becomes better, more complex, or at least different than the sum of the functionalities of the individual transformation chain instances 900B and 900C.

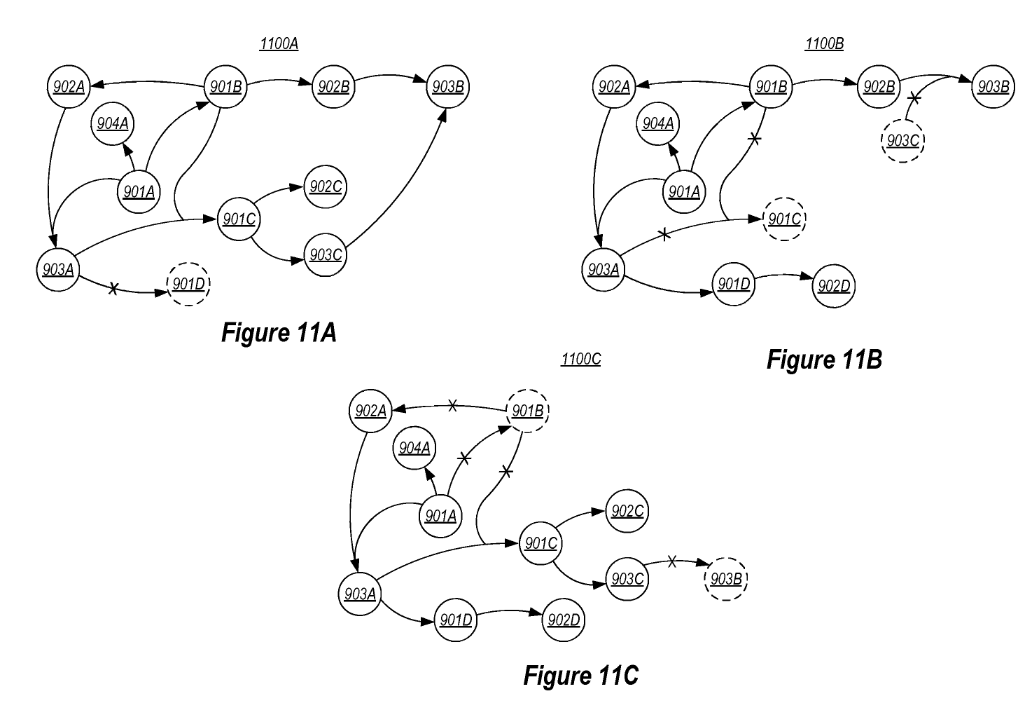

FIG. 11A illustrates a joined transformation chain 1100A that includes transformation chains 900A, 900B and 900C also being joined. Dependency elements in each of the transformation chains are replaced with the actual node referred to the extent that the dependency element refers to a node within any of transformation chains 900A, 900B or 900C. Note that all of the illustrated nodes are actually nodes in the transformation chain, except for dependency element 901D. The functionality of the compound application becomes better, more complex, or at least different than the sum of the functionality of the individual transformation chains 900A, 900B and 900C; the sum of the functionality of the individual transformation chains 1000A and 900C; or the sum of the functionality of the individual transformation chains 900A and 1000B.

The transformation chain 900D includes two nodes 901D and 902D. However, the transformation chain 900D also includes a single dependency element 903A referencing a node in a different transformation chain class 900A. Again, instances of the transformation chain class 900D may operate independently as a single application. For instance, a copy of a value or copies of values from data source 901D may be provided through a transformation to generate a resulting value or values for data target 902D.

Though transformation chain instances 900A and 900D may operate independently, FIG. 10D illustrates a joined transformation chain 1000D that includes transformation chain 900A joined with transformation chain 900D. Dependency elements in each of the transformation chains are now replaced with the actual node referred to the extent that the dependency element refers to a node within any of transformation chains 900A or 900D. Now all of the nodes that have the suffix A or D are nodes within the transformation chain, and only those nodes that have suffixes B or C are dependency elements. For instance, nodes 901A, 902A, 903A, 904A, 901D and 902D are nodes within the augmented transformation chain 1000D, and the functionality of the compound application becomes somewhat better than the sum of the functionality of the individual transformation chain 900A and 900D.

Note that FIGS. 10A through 10D illustrate all of the possible permutations involving two and only two of the transformation chains 900A, 900B, 900C and 900D. The transformation chains 900B and 900D are not joined directly in a two transformation chain combination, since neither transformation chain has a dependency element referring to a node in the other transformation chain. Furthermore, transformation 900C and 900D are not joined directly in a two transformation chain combination, since neither has a dependency reference to the other.

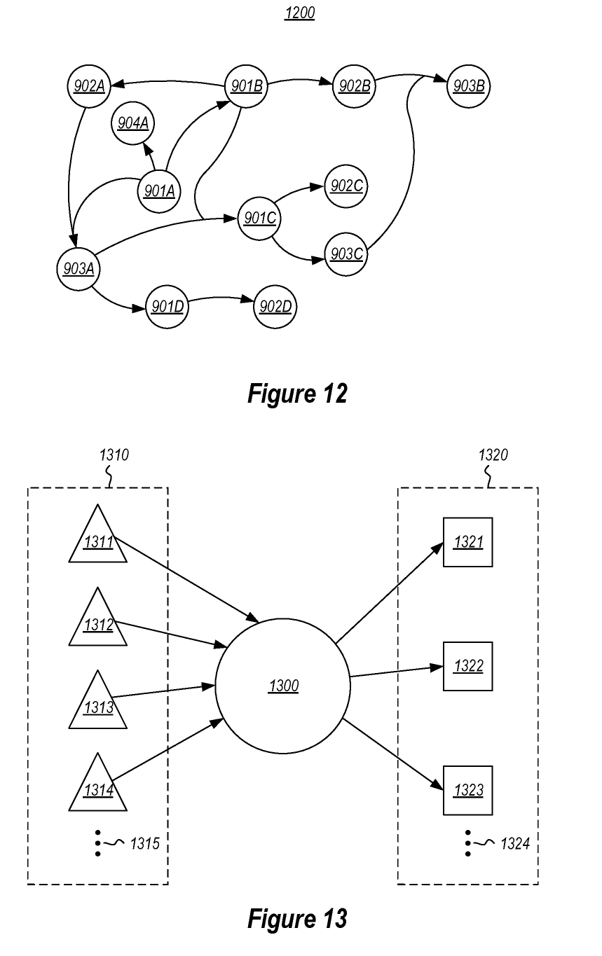

FIG. 11A illustrates one of three possible combinations of three and only three transformation chains 900A, 900B, 900C and 900D. In particular, FIG. 11A illustrates an augmented transformation chain 1100A that combines transformation chains 900A, 900B and 900C. FIG. 11B illustrates an augmented transformation chain 1100B that combines transformation chains 900A, 900B and 900D (in which all nodes are part of the transformation chain except dependency elements 901C and 903C). FIG. 11C illustrates an augmented transformation chain 1100C that combines transformation chains 900A, 900C and 900D (in which all nodes are part of the transformation chain except dependency elements 901B and 903B). Note that there is no combination of transformation chains 900B, 900C, and 900D illustrated since the transformation chain 900D includes no dependency references to transformation chain 900B (or vice versa), or to transformation chain 900C (or vice versa). FIG. 12 illustrates a combined transformation chain 1200 that includes all of the transformation chains 900A, 900B, 900C and 900D combined.

Accordingly, given the transformation chains 900A, 900B, 900C and 900D in the environment, there are 8 possible compound applications that may be formed (corresponding to the transformation chains of FIGS. 10A through 10D, FIGS. 11A through 11C, and FIG. 12). Thus, as the transformation chains of various devices are joined into and decoupled from the environment, the very transformation chain itself changes, and the structure of the compound application thereby changes. For instance, a change in the value of data source 901A might have a very different impact on the transformation chain as the effects of that change are automatically propagated through one or more transformations, depending on whether that data source 901A is within transformation chain 900A alone, within transformation chain 1000A, within transformation chain 1000B, within transformation chain 1000D, within transformation chain 1100A, within transformation chain 1100B, within transformation chain 1100C, or within transformation chain 1200.

Any of the nodes of a transformation chain may have zero or more input endpoints where inputs are received from an endpoint interface entity, and zero or more output endpoints where outputs are provided to an endpoint interface entity. In this description and in the claims, an “endpoint interface entity” is defined as a hardware entity and zero of more environmental criteria. In the case of there being zero environmental criteria associated with an endpoint interface entity, the endpoint interface is simply a hardware entity (such as a device or computing system). In the description and in the claims, “a hardware entity” refers to any single or combination of physical items that have the capability to potentially interface with an endpoint. For instance, a hardware entity that provides input or receives input might be a data store, or a location in a data store, a user device, a microphone or microphone array, a camera or camera array, three-dimensional sensors, image recognizers, or the like. If the hardware entity and corresponding one or more environmental criteria together define an endpoint interface entity, then the hardware entity is indeed the endpoint interface entity so long as the environmental criteria are satisfied. However, if the environmental criteria cease to be satisfied, then the hardware entity would lose its status as an endpoint interface entity.

In this description, the terms “endpoint interface entity” and “hardware entity” may frequently be used interchangeably on the assumption that if the endpoint interface entity does have environmental criteria, that those criteria remain satisfied in that case. Furthermore, when the term “environmental criteria” is mentioned with respect to a hardware entity or an endpoint interface entity, the environmental criteria for the hardware entity becoming the endpoint interface entity may be different than the environment criteria for the hardware entity ceasing to be the endpoint interface entity. Thus, there may be some hysteresis built into the environmental criteria to avoid rapid changes in whether or not a particular hardware entity qualifies as a particular endpoint interface entity.

Examples of environmental criteria will now be provided with the understanding that the principles described herein are not limited to any particular environment criteria. One environmental criterion might be that the hardware entity has an associated identified user or identified group of users. For instance, if a given user or group of users is using a hardware entity, then the hardware entity may become an endpoint interface entity. If another user or group of users is using the hardware entity, then perhaps the hardware entity does not act as an endpoint interface entity. Other examples of environmental criteria might include the position, vantage point, or orientation of a user or group of users within an environment and/or with respect to a hardware entity, the position of an audio source in the environment, background noise levels, whether an audio signature is present, whether a security zone surrounding the environment has been violated, whether an individual has fallen in the environment, the temperature of the environment, the available network connections in the environment, a lighting level and/or configuration, a time of day or week or month or year, and so on for any imaginable environmental criteria.

As an example, a mounted flat panel display having multiple viewers oriented to be able to see the flat panel display might be an appropriate endpoint interface device, but if there is but a single viewer, and the node has input endpoints, perhaps a touchscreen device in the hands of the single viewer might be the better endpoint interface device for a given endpoint. As a second example, suppose that there was output was being displayed on a television, and a security system is activated, the activation of the security system might be an environmental criteria that causes some or all of the information displayed on the television to be obscured, or perhaps even cause the television to stop being an endpoint interface entity, and thus disconnect from the application.

FIG. 13 illustrates a node 1300 of a transformation chain that includes input endpoints 1310 and output endpoints 1320. The input endpoints 1310 are illustrated as including endpoints 1311 through 1314, are represented as triangles, with the ellipses 1315 representing that the node 1300 may have any number of input endpoints. The output endpoints 1320 are illustrated as including endpoints 1321 through 1323, are represented as squares, with the ellipses 1324 representing that the node 1300 may have any number of output endpoints. The number and type of input and output endpoints may be defined by the transformation chain class(es) that include the node, or the class may provide flexibility in how many input and/or output endpoints are included with each instance of node 1300 in its respective instances of those transformation chain class(es). The endpoints themselves may be considered to be trivial nodes of a transformation class as all they do is provide output to, or receive input from a respective endpoint interface entity. The endpoints are generally not illustrated in FIGS. 1 through 12. The endpoint are however, the mechanism by which the transformation chains interact with the physical world through storage, display, input, actuation, audio, text, or the like.

The general concept of the transformation chains has been described with respect to FIGS. 1 through 13 with respect to specific examples of transformation chains that have particular nodes and particular dependency elements. However, the principles described herein apply to any transformation chain having any number of nodes and any number of dependency elements, regardless of the function of the node and identity of the dependency element. Accordingly, the principles described herein may be applied to a limitless variety of transformation chains performing a limitless variety of functions. One or more endpoint interface entities have credentials to interface with the endpoints of a transformation chain instance or portions thereof. Such credentials may include credentials to provide input to some or all of the endpoints of one or more or all nodes of a transformation chain instance, credentials to receive output from some or all of the endpoints of one or more or all nodes of a transformation chain instance, or even the power to delegate credentialed power to one or more delegate endpoint interface entities.

Transformation Chain Supporting Architecture

In accordance with the principles described herein, an architecture is described in which transformation chains may be combined incrementally forming dynamically changing functions at runtime, thereby changing the concept of what an application is. With the benefit of reading this description, transformation chains are like molecules floating within an environment, and with the proper impetus, such molecules combine resulting in a compound that operates differently from its constituent parts. For instance, given the right impetus, two hydrogen molecules may combine with an oxygen atom to formulate a molecule of water. While liquid hydrogen and liquid oxygen cannot be consumed by humans, liquid water can and must be consumed by human beings. Thus, the principles described herein allow molecules of transformation chains to be joined dynamically and incrementally to formulate customized applications that provide customized functionality that is suitable to the impetus experienced. Such applications may be so customized that there may be times that a particular application is only constructed once.

The principles described herein also allow a delegator endpoint interface entity to delegate power to another delegate endpoint interface entity to interface with certain endpoints, without the delegator endpoint interface entity giving up control of how the delegate endpoint interface affects the transformation chain instance. Accordingly, the principles described herein also allow a transformation chain to be safely split.

Through atomic and molecular composition, a seemingly infinite variety of animate and inanimate objects, and entire worlds, have formed. Currently, there are only 115 known elements in the periodic table of the elements from which an infinite variety of animate and inanimate objects throughout the universe are composed. Using only a limited number of transformation chains, that may be combined in certain ways, there is a substantially limitless variety of applications of a substantially limitless variety of functions that may be generated in a universe of possible applications. Accordingly, the principles described herein describe a new organic paradigm in incrementally building application and sharing split applications to suit the very present circumstances. Furthermore, the principles described herein allow for the careful tracking of credentials of which endpoint interface entity may interact with which endpoint of which nodes of which transformation chains, and allows for temporary, or even permanent delegation of such credentials to other endpoint interface entities. Accordingly, a wide variety of collaboration scenarios are enabled in such an organic application environment.

FIG. 14 illustrates a runtime architecture 1400 in which this new paradigm in applications may be implemented. The runtime architecture 1400 includes a universal canvas 1410. The universal canvas 1410 represents the universe in which transformation chain instances are formed, combined, operated, and extinguished. As an example, the universal canvas 1410 is illustrated as operating eight transformation chains 1411 through 1418 of varying complexity. However, the ellipses 1419 represent that the universal canvas 1410 may run many transformation chain instances. Given sufficient resources, the universal canvas 1410 may even run millions or billions of application chain instances.

The runtime architecture also includes a supporting architecture 1420 that includes modules and components that operate outside of the observable universal canvas 1410, to ensure the appropriate formation, combination, sharing, operation, and extinguishing of the transformation chain instances. The supporting architecture 1420 itself can receive input and provide output at represented by bi-directional arrow 1421. The supporting architecture 1420 may also provide access to services as represented by bi-directional arrow 1422. The supporting architecture 1420 also interacts with the universal canvas 1410 as represented by the bi-directional arrow 1423 for purposes of instantiating transformation chains, combining transformation chain instances, altering transformation chain instances, enforcing credentialed use of the transformation chain instances by appropriate endpoint interface entities, extinguishing transformation chain instances, and the like.

The precise physical platform on which the universal canvas 1410 is run is not critical. In fact, there can be great flexibility and dynamic change in the physical platform on which the universal canvas 1410 is operated. Some nodes of some transformation chains may be operated by one physical platform (such as a device, endpoint interface entity, system, or cloud, while other nodes operate another physical platform). In one embodiment, the universal canvas 1410 operates in a cloud computing environment, such as a private cloud, a hybrid cloud, or a public cloud. As an example, the universal campus may be within a local network, in a peer-to-peer computing network, in a cloud computing environment, in any other network configuration, or in any combination of the above. Even so, as previously mentioned, the universal canvas interfaces with the physical world through the endpoints of the various nodes of the transformation chain instances.

Likewise, the supporting architecture 1420 may be operated in any computing environment, in peer-to-peer computing network, in a local network, any other network configuration, or in any combination of these. In the case where the transformation chain instances within the universal campus 1410 operate fully or primarily, or even party in a cloud computing environment, it may be this same cloud computing environment that operates the supporting architecture.

In this description and the following claims, “cloud computing” is defined as a model for enabling on-demand network access to a shared pool of configurable computing resources (e.g., networks, servers, storage, applications, and services). The definition of “cloud computing” is not limited to any of the other numerous advantages that can be obtained from such a model when properly deployed.

For instance, cloud computing is currently employed in the marketplace so as to offer ubiquitous and convenient on-demand access to the shared pool of configurable computing resources. Furthermore, the shared pool of configurable computing resources can be rapidly provisioned via virtualization and released with low management effort or service provider interaction, and then scaled accordingly.

A cloud computing model can be composed of various characteristics such as on-demand self-service, broad network access, resource pooling, rapid elasticity, measured service, and so forth. A cloud computing model may also come in the form of various service models such as, for example, Software as a Service (“SaaS”), Platform as a Service (“PaaS”), and Infrastructure as a Service (“IaaS”). The cloud computing model may also be deployed using different deployment models such as private cloud, community cloud, public cloud, hybrid cloud, and so forth. In this description and in the claims, a “cloud computing environment” is an environment in which cloud computing is employed.

The supporting environment 1420 includes a number of modules 1430. One of the modules 1430 is a summoning module 1431 that interprets input and in response determines that a class of a transformation chain is to be instantiated. For instance, the input may be received directly from input (from arrow 1421) to the supporting environment 1420 or via input from a transformation chain instance running in the universal canvas 1410 itself. Input that may be received from either source will be referred to herein as “general input”. Summoning criteria are used for recognizing that certain general input is to result in a transformation chain instance being created. Summoning criteria may be also any environmental criteria at all. For instance, the summoning criteria may take into account not just verbal conversations, or explicit user input directed at a hardware entity, but may also take into consideration other environmental factors. For instance, whether a particular user is sitting down, moving away, looking somewhere, being near a device with a touch screen, and so forth, may also be environmental criteria used as summoning criteria for summoning an instance of a transformation chain class to be created within the universal canvas 1410.

The modules 1430 also includes a chain class module 1432 that instantiates transformation chain instances in response to determinations made by the summoning module 1431 and/or in response to general input.

The modules 1430 also includes a chain class maintenance module 1433 that maintains a copy of each transformation chain class. The chain class maintenance module 1433 may add to the library of available transformation chain classes in response to a determination made by the summonsing module 1431 and/or in response to general input. Thus, the chain class maintenance module may maintain a registry of transformation chain classes. For instance, the chain class maintenance module 1433 might merge classes along their appropriate points of dependency, or perhaps create a transformation chain class that represents a redacted or truncated version of a pre-existing transformation chain class. Some transformation chain classes may be created temporarily, whilst others may have more lasting persistence. Furthermore, authentication and authorization may be imposed so as to restrict which entities may instantiate transformation chains of certain classes.

A merging module 1434 merges instances of transformation chains to be operated in the universal canvas 1410 in an appropriate way given the dependencies of the transformation chains. Such merging occurs in response to determinations made by the summoning module 1431 and/or in response to other general input. The merging criteria may also be any general environment criteria. Again, the merging criteria may take into account not just verbal conversations, or explicit user input directed at a hardware entity, but may also take into consideration other environmental factors that are deemed appropriate for the merging to occur.

An endpoint interface entity registry module 1435 maintains a registry of all possible endpoint interface entities (hardware entities and potentially associated user criteria), as well as which endpoint interface entities are presently active and available given a particular instantiated transformation chain operating within the universal canvas 1410.

An environmental module 1436 detects when endpoint interface entities become active or inactive for a given instantiated transformation chain operating within the universal canvas 1410. For instance, the environmental module 1436 might detect when an initiating set of environment criteria for a hardware entity of a particular endpoint interface entity begin to be met resulting in the endpoint interface entity being available for the application (for interacting with the endpoints of the application). Likewise, the environment module 1436 might detect when a terminating set of one or more environmental criteria for the hardware entity of the particular entity is met resulting in the endpoint interface entity no longer being available for the application.

An endpoint matching module 1437 determines which active endpoint interface entities for an instantiated transformation chain are capable of and credentialed to provide input for each input endpoint of that transformation chain that is capable of receiving input from the physical world, and determining a proper form of the input given that endpoint interface entity. The endpoint matching module 1437 also determines which active endpoint interface entities for an instantiated transformation chain are capable of and credentialed to receive output for each output endpoint of the transformation chain that is capable of presenting output into the physical world.

The modules 1430 includes a presentation module 1438 that, when there are multiple eligible endpoint interface entities that are capable of providing input into an input endpoint, decides which endpoint interface entity is to provide that input, and potentially decides that multiple endpoint interface entities are capable of providing input into that input endpoint. Furthermore, when there are multiple eligible endpoint interface entities that are capable of rendering output from an output endpoint, the presentation module 1438 decides which endpoint interface entity is to provide that input, and potentially decides which of multiple endpoint interface entities are to render the output received from the output endpoint.

The presentation module 1438 also decides whether any restrictions are to be imposed when a particular endpoint interface module provides input to an input endpoint of a transformation chain. The presentation module 1438 may also decide whether there are any restrictions that are to be imposed when a particular endpoint interface module renders output from an output endpoint of a transformation chain. When that output is visualizations, the presentation module 1438 may decide how visualized information is to be formatted and/or laid out on the display of the endpoint interface entity.

The modules 1430 also includes a delegation module 1439 that allows and facilitates credentialed endpoint interface entity to delegate power to a delegee endpoint interface entity with respect to receiving output from or providing input to particular endpoints of a transformation chain instance. As such, delegation module 1439 facilitates splitting of transformation chain application, thereby allowing dynamic movement into and out of collaborative scenarios. There may be other modules within the modules 1430 as represented by the ellipses 1440.

Transformation Chain Operation

Having now described transformation chain applications, and an architecture that facilitates operation of transformation chain applications with respect to FIGS. 6 through 14, example operations of the transformation chains and the supporting architecture will now be described with respect to FIGS. 15 through 23. First, the dynamic building of transformation chain instances will be described.

The dynamic building of transformation chain instances will now be described. In accordance with the principles described herein, transformation chains may be combined incrementally and with ease of effort forming dynamically changing functions at runtime. Transformation chains are like molecules floating within an environment, and with the proper impetus, such molecules combine resulting in a compound that operates differently from its constituent parts. Thus, the principles described herein allow instances of transformation chains to be joined dynamically and incrementally to formulate customized applications that provide customized functionality that is suitable to the impetus experienced.

As a concrete example, suppose that there is a transformation chain that extracts received orders from a database. A verbal command to “show me my orders” by a sales representative might instantiate that transformation chain class, filter by the user that stated the verbal command, and visualize the filtered list or orders. A subsequent join instruction might be “Fetch me my customers”, which might then cause another transformation chain to automatically join with the prior transformation chain to match customers with orders, and visualize the orders by customers. The user might then state “add order exceptions for customers” causing perhaps yet another transformation chain to join the existing transformation chain aggregation, and/or cause input to be made to an existing node of the current aggregation of transformation chains. At each stage, the user may determine based on the current state of the aggregated transformation chain what is lacking, and state or input further joining instructions, from which yet other transformation chains may be join in the growing customized application chain. In essence, the application is built as the user thinks and expresses intuitively what he or she wants, and the application is built in a manner that is sensitive to the environment.

FIG. 15 illustrates a flowchart of a method 1500 for formulating an application in response to detecting one or more environment events, which represents a simple case in which an instance of a transformation chain is created and operated within the universal canvas 1410. First, a set of one or more environmental events (e.g., the presence of a user) is detected (act 1501). For instance, the summoning module 1431 might detect one or more environmental events that are to trigger instantiation of a particular transformation chain class.

Responsive to the detected environment event(s), the transformation class corresponding to the input is selected (act 1502). For instance, the summoning module 1431 or the chain class module 1432 may select which of the available transformation chain classes (maintained by the chain class maintenance module 1423) corresponds to the detected environmental event(s).

An instance of the transformation chain class is then created (act 1503). For instance, the chain class module 1432 might instantiate an instance of the identified transformation chain class. When instantiating the transformation chain class, the endpoint interface entity matching module 1437 may provide appropriate credentials to one or more appropriate endpoint interface entities so that such entities are credentialed to receive output from and/or provide input to one or more endpoints of the transformation chain instance.

Optionally, the instance may then be operated (act 1504). For instance, in FIG. 14, the instance of the transformation chain class may be deployed and operated within the universal canvas 1410.

As part of this operation (act 1504), the environmental module 1436 detects which of the registered endpoint interface entities are active for the given instantiated transformation chain. Furthermore, the endpoint interface entity matching module 1437 determines which active endpoint interface entity endpoints for the instantiated transformation chain should provide input for each endpoint of each node of the transformation chain that is capable of receiving input from the physical world, and what forms of input are acceptable. Furthermore, the endpoint interface entity matching module 1437 determines which active endpoint interface entities for the instantiated transformation chain should receive output for each output endpoint of each node of the transformation chain that is capable of realizing (e.g., visualizing, rendering, sounding, storing, actuating, and the like) output into the physical world, and what forms of output are acceptable.

At some point, further environmental event(s) are detected (such as user input) which directs that an instance of another transformation chain class is to be combined with an existing transformation chain instance. Accordingly, FIG. 16 illustrates a flowchart of a method 1600 for responding to further detected environment event(s) to thereby combine transformation chain instances. The method 1600 is initiated by detecting further environmental event(s) (act 1601) that is constituent with combination of two instances of transformation classes.

As an example, a transformation chain instance may be combined with the instance created in method 1500, or perhaps may be combined with an instance of a transformation chain created by a previous performance of the method 1600 of FIG. 16. Although not required, the instance to which the transformation chain instance is to be joined may have previously operated as an application already. Thus, the method 1600 may be repeatedly performed in order to build a sophisticated and customized transformation chain in response to various detected environmental events.

The detected environment events of act 1601 may be an expressed instruction to join. For instance, the user might have a user interface that allows explicit selection of a desired application chain class to be instantiated. Alternatively, the detected environment events of act 1601 may simply be an implicit indication that two transformation chain instances should be joined. For instance, the detected environment events might be any activity, such as particular speech, that is consistent with the joining of two instances of different transformation chain classes. Such input could include gestures, requests, and the like. For instance, as previously mentioned, a sales representative might state “fetch me my customers” in the context of the representatives corresponding orders already being visualized. The system may even guess at what transformation chain the user might want based on history and current context. In that case, the user establishing the current context could be the environmental event(s) that cause the new transformation chain to be instantiated that the system guesses may be desired at some future point. For instance, perhaps the system knows that when in a particular conversation the users keep talking about a particular order, the system might join transformation chain instances used to acquire that order in anticipation of showing that order. Whatever form the joining environment event(s) takes, the summoning module 1431 of FIG. 14 detects appropriate environmental event(s) that corresponds to the instantiation of a transformation chain class (as described with respect to FIG. 15) or the joining of two transformation instances (as will be described with respect to FIG. 16).

The method 1600 then includes determining, from the further detected environmental event(s), that an instance of one transformation chain class is to be joined with an instance of another transformation chain class (act 1602). For instance, as described above, there are class-level restrictions in which the transformation chain class author expressly makes it possible, at least under some conditions, for instances of two transformation chain classes to be joined. For instance, the dependency elements of FIGS. 9A through 11C are an example of such class-level restrictions and authorizations.

However, there may also be instance-level authorization. As an example, the act 1502 may involve consulting a set of one or more rules defining one or more conditions for joining an instance of the first transformation chain class and the second transformation chain class. This set of rules may be dynamic and change over time. For instance, the joining logic may learn over time that certain gestures or other user activity is, or is not, indicative of a user intent or anticipated future user intent to combine such instances. Accordingly, the supporting architecture may observe a history associated with each of multiple users in order to, over time, more accurately predict user intention, depending on a history of a particular user, or group of users, and thereby formulate an appropriate set of summoning and merging criteria. The act 1602 may be performed by, for instance, by the chain class module 1432 with reference to the transformation chain classes known to the class maintenance module 1433. The endpoint interface entity matching module 1437 may reevaluate which endpoint interface entities have credentials to interface with which endpoints of the composite aggregated transformation chain instance.

The author of a transformation chain class might also express restrictions at the granularity of a single dependency. For instance, in the dependence element 901B of transformation chain class 900A, the author might express that joining is authorized on that dependency element only if the transformation chain into which it is joined does not include an identified transformation chain class authored by a competitor. The author might also control data that is flowed out of the transformation chain to another joined transformation chain by writing restrictions or conditions into the transformation that would bridge the dependency itself (e.g., between nodes 901A and dependency element 901B).

However, even though transformation chain classes may interoperate, that does not mean that the user wants their particular instance of that transformation chain class to join with other instances of other transformation chain classes. After all, the data itself (e.g., the instance state) might be sensitive to the user. Accordingly, the method also may include determining that instances of different transformation chain classes are to be joined.

The joining criteria for authorizing two instance of different transformation chain classes to join may include one or more of the following: whether or not the user is on a meeting attendee list, a relationship (e.g., family, social network friend, or the like) of users of the various devices, a communication capability (e.g., near field) between the devices, a proximity of the respective devices (e.g., in the same conference room), the request of the users, of the like. For instance, the joining criteria might include some business criteria such as the associated users of the instances are on the same team. As another example, one device might be a kiosk in a retail space or hotel, where a customer uses the kiosk and a shop assistant or concierge can automatically use their device to join their transformation chain with that of the kiosk to thereby interact with the customer using the compound application. Conditions may be applied to the joining criteria. For instance, a bellhop's device might be able to join a customer's application if the concierge is not around (perhaps detected by the concierge not actively using the pairable application to join with that of customers, or being off network).

In some embodiments, the first transformation chain class used to instantiate the first of the two instances to be joined may be derived from an existing transformation chain class. As an example, the first transformation chain class may be the same as the first transformation chain class, except with one or more nodes of the transformation chain removed.

In response to the act of determining that the two instances are to be joined (act 1602), the two instances are joined (act 1603), so as to establish connections across one or more flow dependencies of the instance, thereby creating new avenues for data flow, and new application functionality. For instance, this joining may be accomplished by the merging module 1434. The joined instance may thereafter be operated (act 1604).

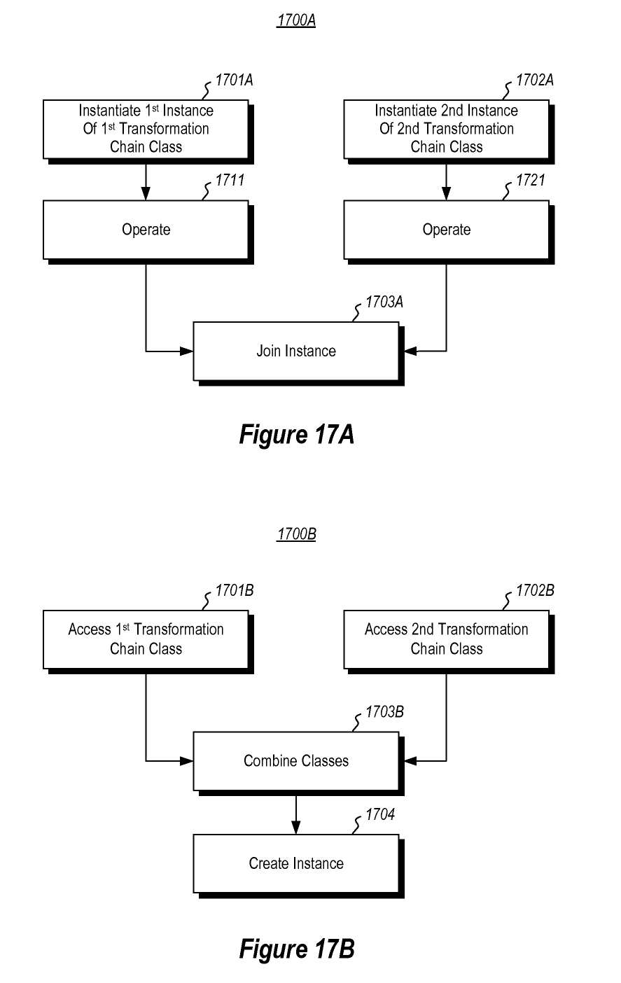

In one embodiment, the instances themselves are directed joined without defining any new combined transformation chain classes. For instance, FIG. 17A illustrates a flowchart of a method 1700A for joining two instances and represents an example of the act 1603 of FIG. 16. The first instance of the first transformation chain class is instantiated (act 1701A) and perhaps operated (act 1711). Furthermore, the second instance of the second transformation chain class is instantiated (act 1702A) and perhaps operated (act 1721). Thereafter, the two instances are joined (act 1703A).

In other embodiments, the transformation chain classes themselves are aggregated to define a new combined class, and an instance of that aggregated class is instantiated to thereby accomplish act 1603. The combined instance may exist temporarily, may be kept for the benefit of a limited number of one or more users, or may even be added to the library of transformation chain classes that are available for more widespread use. For instance, FIG. 17B illustrates a flowchart of a method 1700B that represents another example of the act 1603 of FIG. 16. The first transformation chain class is accessed (act 1701B) and the second transformation chain class is accessed (act 1702B). The two classes are then combined (act 1703B). An instance is then created from the combined transformation chain class (act 1704).

As an example only, perhaps method 1500 or act 1701A of method 1700A might be employed to create an instance of a transformation chain of FIG. 9A. Now suppose that environmental event(s) are detected that suggest combination of instances of transformation chains of FIGS. 9A and 9B. Method 1600 may then be performed to create the instance of the transformation chain of FIG. 10A. In that case, act 1701A of method 1700 would instantiate from the transformation chain class of FIG. 9A, and act 1702A of method 1700 would instantiate from the transformation chain class of FIG. 9B. The result may be thought of as an instantiation of the aggregated class of the classes of FIGS. 9A and 9B (which is represented in FIG. 10A).

Now suppose that environmental event(s) are detected that suggest combination of instances of transformation chains of FIGS. 10A and 9C. The method 1600 may then be performed to create the instance of the transformation chain of FIG. 10A. In that case, act 1701A of method 1700A would be used to instantiate (in which the result from the prior performance of the method to create the transformation chain instance of FIG. 10A could be viewed as instantiating from the aggregated classes of FIGS. 9A and 9B) an instance of FIG. 10A. Furthermore, act 1701B of method 1700 would be used instantiate from the transformation chain class of FIG. 9C. The result may be thought of as an instantiation of the aggregated class of the classes of FIGS. 10A and 9C (which is represented in FIG. 11A).

Now suppose that environmental events are detected that suggests combination of instances of transformation chains of FIGS. 11A and 9D. The method 1600 may then be performed to create the instance of the transformation chain of FIG. 11A. In that case, act 1701A of method 1700A would be used to instantiate an instance of FIG. 11A. Furthermore, act 1701B of method 1700 would be used instantiate from the transformation chain class of FIG. 9D. The result may be thought of as an instantiation of the aggregated class of the classes of FIGS. 11A and 9D (which is represented in FIG. 12).

Having now described the general principles of transformation chains, the environment in which they may operate, and their principles of aggregation, this description will now address how a delegator endpoint interface entity having credentials on a transformation chain instance may delegate power to a delegee endpoint interface entity to receive output from particular endpoint(s) and/or provided input to particular endpoint(s). Accordingly, application splitting and sharing is made possible in this organic universal canvas of transformation chain instances.

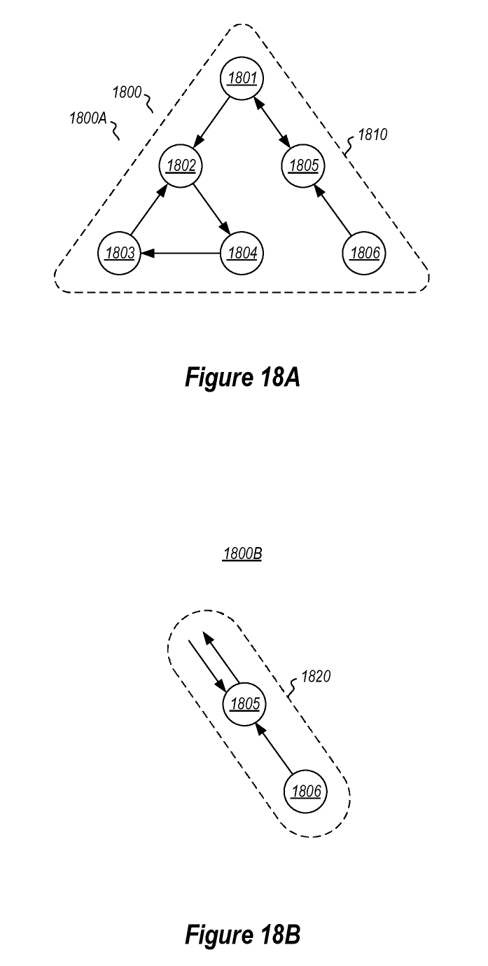

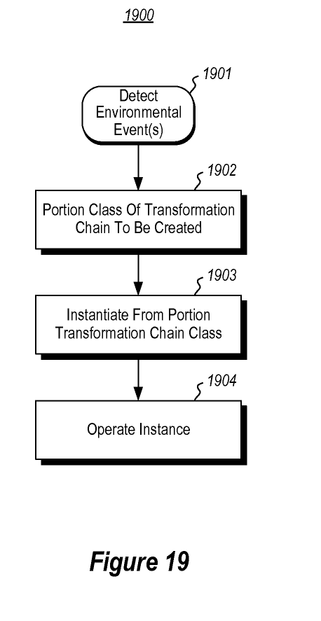

FIG. 18A illustrates an example transformation chain 1800 in a state 1800A in which it is about to be split. FIG. 19 illustrates a flowchart of a method 1900 for formulating a split application. As the method 1900 may be performed in the context of the example transformation chains 1800A and 1800B of FIGS. 18A and 18B, respectively, the method 1900 of FIG. 19 will be described with frequent reference to the example transformation chains 1800A and 1800B.

As illustrated in FIG. 18A, the example transformation chain 1800A includes six nodes 1801 through 1806. Each of the nodes may have zero or more input endpoints and zero or more output endpoints. However, to keep the diagram cleaner, the endpoints are not illustrated for the example transformation chain 1800A of FIG. 18A. Likewise, the endpoints are not illustrated for the example transformation chain 1800B in FIG. 18B.

In the initial state 1800A of FIG. 18A, a particular endpoint interface entity (referred to herein as a “first endpoint interface entity”) is credentialed to provide input to and receive output from endpoints of transformation chain 1800A. The scope of this credential is represented by the dashed lined boundary 1810.

Now suppose that the application represented by the transformation chain 1800A is to be split. For instance, the application may be split when sets of shareable information that are generated by one portion of the application are to be shared with another output device. In that case, the portion of the application is run on behalf of or on the second output device for rendering of the set of shareable information on the second device.

That is, suppose that the first endpoint interface entity provides interaction or input suggesting that a transformation chain instance representing a portion of the larger transformation chain instance 1800A is to be created (e.g., in response to a “Yes” in decision block 220 of FIG. 2). There may be several reasons for performing such a split. One reason might be simply because the first endpoint interface entity is to use another instance of just that portion of the larger transformation chain class. Another reason might be to delegate input and/or output privileges associated with one, some, or all of the endpoints of those nodes that are part of the portion to another endpoint interface entity. In other words, the first endpoint interface entity assigns the portion of the transformation chain, at least temporarily, to the second endpoint interface entity. A redaction and share gesture may be used to express this intent to delegate. For instance, a user might cross over a certain portion of the user interface (indicating that the target endpoint interface entity is not to have the ability to view or input into those fields), and then indicate a share gesture.

In any case, interaction and/or environmental event(s) are detected that are representative of splitting an instance of a smaller class off of the larger transformation chain class (act 1901), thereby initiating the method 1900 of FIG. 19. Based on the detected environment event(s), the system determines that a portion transformation chain class is to be created (act 1902) that represents a portion of the larger transformation chain class. This determination might be made by, for instance, the delegation module 1439 of FIG. 14. For instance, referring to FIG. 18A, suppose that a portion transformation chain class is to be created that is represented only by nodes 1805 and 1806. In response, an instance of the portion transformation chain class is instantiated (act 1903) and operated (act 1904). For instance, the second endpoint interface entity may be instructed (by the first endpoint interface entity and/or by the delegation module 1439) to interact with the endpoints of the instantiated portion transformation chain class. The instantiated portion transformation chain class may be sent to the second endpoint interface entity.

FIG. 18B represents the portion resulting transformation chain 1800B that includes just the node 1805 and the node 1806. A dotted lined border 1820 is illustrated to represent that a particular endpoint interface entity may have credentials to interface with some or all of the endpoints of the nodes 1805 and 1806. In one embodiment, the splitting is not made for purposes of delegation, and the first endpoint interface entity also has credentials to interface with the endpoints of nodes 1805 and 1806 in the new portion transformation chain 1800B. However, a very useful scenario is that the first endpoint interface entity has delegated privileges to a second endpoint interface entity to interface with at least some endpoints of the nodes 1805 and 1806 of the portion transformation chain 1800B.

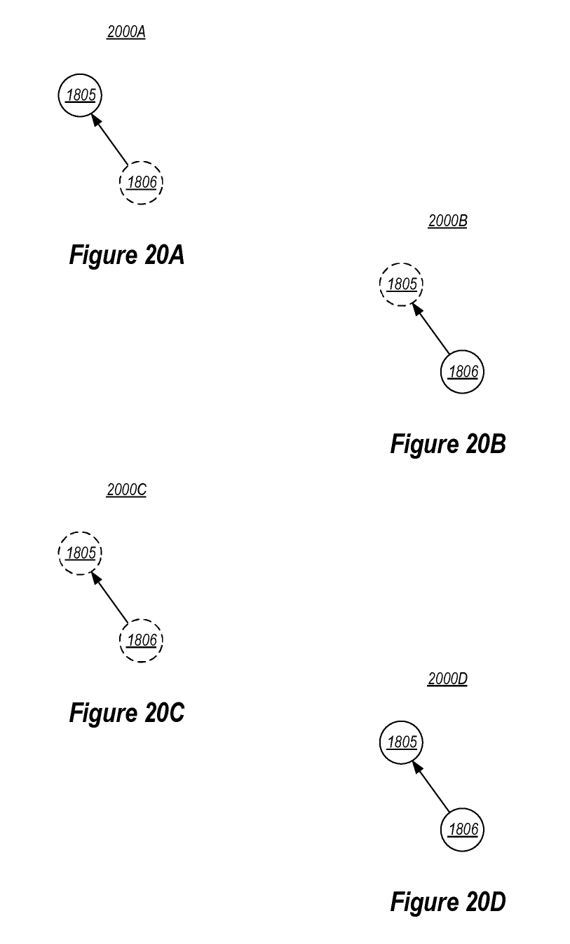

FIG. 20A through 20D illustrate several possible embodiments of how such delegation might occur from the perspective of the portion transformation chain 1800B. In the symbolism of FIGS. 20A through 20D, a node represented by dashed lined borders represents a node of which only some of the endpoints of the original node are available for interfacing with the second endpoint interface entity.

In the embodiment 2000A of FIG. 20A, the node 1805 is illustrated with as a solid circle, representing that all endpoints of the node 1805 have been instantiated and made available to the second endpoint interface entity. Meanwhile, the node 1806 is illustrated with a dashed-lined circle, representing that only a portion of the endpoints of the node 1806 have been instantiated and made available to the second endpoint interface entity.

In the embodiment 2000B of FIG. 20B, the node 1806 is illustrated with as a solid circle, representing that all endpoints of the node 1806 have been instantiated and made available to the second endpoint interface entity. Meanwhile, the node 1805 is illustrated with a dashed-lined circle, representing that only a portion of the endpoints of the node 1805 have been instantiated and made available to the second endpoint interface entity.

In the embodiment 2000C of FIG. 20C, the nodes 1805 and 1806 are both illustrated with a dashed-lined circle, representing that only a portion of the endpoints of each of the nodes 1805 and 1806 have been instantiated and made available to the second endpoint interface entity.

In the embodiment 2000D of FIG. 20D, the nodes 1805 and 1806 are both illustrated as a solid circuit, representing that all of the endpoints of each of the nodes 1805 and 1806 have been instantiated and made available to the second endpoint interface entity.

Note that there need be no change to the instance of the transformation chain 1800 that is in state 1800A from the perspective of the first endpoint interface entity. In that case, whatever endpoints are created for nodes 1805 and 1806 for the second endpoint interface entity may simply be cloned endpoints. During operation, if a cloned input endpoint received inconsistent input from both the first endpoint interface entity and the second interface entity, merging criteria may resolve the inconsistency. For instance, perhaps inconsistencies are resolved in favor of the delegating endpoint interface entity. Merging operations may be provided by, for instance, the delegation module 1439 of FIG. 14.

In an alternative embodiment, a remainder instance may be created that represents a logical remainder when the portion instance 1800B is subtracted from the larger instance 1800A, and thus no endpoint are cloned at all. For instance, in the case of FIG. 20D, in which the second endpoint interface entity is given access to all endpoints of the nodes 1805 and 1805, a remainder instance may be created with just the nodes 1801 through 1804. In the case of FIG. 20A, the remainder instance might include nodes 1801 through 1804 and a limited form of node and 1806 with only the endpoints that were not included with the node 1806 of the remainder instance being included in the portion instance 2000A. In the case of FIG. 20B, the remainder instance might include nodes 1801 through 1804, and a limited form of node 1805 with only the endpoints that were not included with the node 1805 of the remainder instance being included within the portion instance 2000B. In the case of FIG. 20C, the remainder instance might include nodes 1801 through 1804, and a limited form of node 1805 and 1806 with only the endpoints that were not included with the nodes 1805 and 1806 of the remainder instance being included within the portion instance 2000B.

In operation, the delegation module 1439 may allow the first endpoint interface entity to maintain control or supervision over the actions of the second endpoint interface entity in interacting with the portion 1800B of the transformation chain 1800A. For instance, the second endpoint interface entity may be credentialed through the first endpoint interface with respect to the portion 1800B such that data flows to and from the instance of the portion transformation class 1800B are approved by and/or channeled through the remainder of the transformation chain 1800A controlled by the first endpoint interface entity. Furthermore, the access of the second endpoint interface entity to data (such as a data service) is strictly controlled. Data for nodes that are not within the portion transformation chain class are provided via the approval of the first endpoint interface entity.

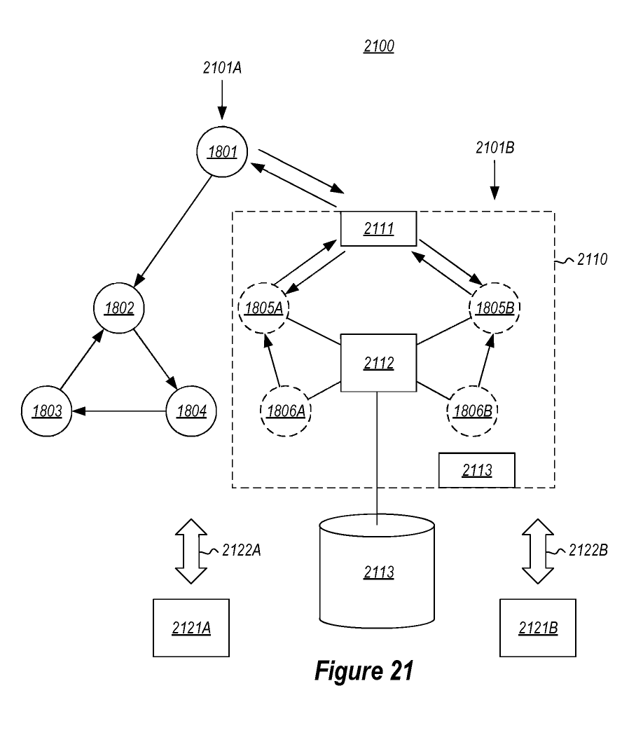

FIG. 21 illustrates an architecture 2100 in which the larger transformation chain instance 2101A that is assigned to a first endpoint interface 2121A securely interfaces with apportion transformation chain instance 2101B that is assigned to a second endpoint interface 2121B via a proxy service 2110.

The larger transformation chain instance 2101A is similar to the transformation chain 1800A of FIG. 18A, except that the first endpoint interface entity 2121A may access only a portion of the endpoints of the node 1805 (now referred to as node 1805A since it now has more limited interfacing capability with the first endpoint interface entity 2121A) and node 1806 (now referred to as node 1806A since it now has more limited interface capability with the first endpoint interface entity 2121A). The ability of the first endpoint interface entity 2121A to interface with the larger transformation chain instance 2101A is represented by bi-directional arrow 2122A.

The portion transformation chain instance 2101B is similar to the portion transformation chain 1800B of FIG. 18B, except that (similar to the case of FIG. 20C) the second endpoint interface entity 2121B may access only a portion of the endpoints of the node 1805 (now referred to as node 1805B since it now has more limited interfacing capability with the second endpoint interface entity 2121B) and node 1806 (now referred to as node 1806B since it now has more limited interface capability with the second endpoint interface entity 2121B). The ability of the second endpoint interface entity 2121B to interface with the portion transformation chain instance 2101B is represented by bi-directional arrow 2122B.

The proxy service 2110 provides a point of abstraction whereby the second endpoint interface entity 2121B may not see or interact with the nodes 1801 through 1804 of the larger transformation chain instance 2101A, nor may the second endpoint interface entity 2121B interface with any of the endpoints of the nodes 1805 and 1806 that are assigned to the first endpoint interface entity 2121A. As an example, the proxy service 2110 may be established by the delegation module 1439 of FIG. 14 at the time that a portion of transformation chain instance is assigned to another endpoint interface instances.

The proxy service 2110 keeps track of which endpoints on node 1805 are assigned to each node 1805A and 1805B, and which endpoints on node 1806 are assigned to each node 1806A and 1806B. When the proxy service 2110 receives input transformations from the larger transformation chain (e.g., node 1801), the proxy service 2110 directs the transformation to each of the nodes 1805A and 1805B as appropriate, depending on which values are affected by the input transformations. Furthermore, when output transformations are provided by the nodes 1805A and 1805B to the node 1801, the proxy service 2110 merges the outputs and provides the merged transformations to the node 1801. For the perspective of the node 1801, it is as though the node 1801 is interacting with node 1805, just as the node 1801 did prior to application splitting. Accordingly, performance and function are preserved, while enabling secure application splitting, by maintaining appropriate information separation between the first and second endpoint interface entities 2121A and 2121B. Such merging of output transformations and splitting of input transformations are performed by component 2111 of the proxy service 2110.

The proxy service 2110 may also include a recording module 2120 that evaluates inputs and outputs made to endpoints in each of the nodes 1805A, 1805B, 1806A and 1806B, and records such inputs and outputs. The recording module 2112 also may record the resulting transformations made between nodes. Such recordings are made into a store 2113. A replay module 2113 allows the actions to be replayed. That may be particular useful if the portion transformation chain is assigned to another (i.e., a third) endpoint interface entity later on and a user of that third endpoint interface entity wants to see what was done. That third endpoint interface may come up to speed with what happened during the tenure of the second endpoint interface entity with the portion transformation chain. Another reason to replay might be to check, and approve, commit, or ratify some action. For instance, imagine an order editing scenario where a number of users are seeking to postpone or move back some deliveries. A first user might ask a second user to help with this. However, the first user does not want the second user to edit the order in a way that causes permanent side effects (e.g., some shipping slot gets released and some now slot gets booked due to a service call). The first user might want to replay what the second user did, and if the first user like was she sees, then accept and commit the actions taken. Here, the replay mechanism additionally simulates the side effecting service calls for the second users. Then, on replay, the first user may cause those service calls to be bound to the actual services. The proxy service 2110 further ensures that the limited credentials of the second endpoint interface entity are enforced. For instance, endpoints on the nodes 1805B and 1806B may not receive proprietary data owned by the first endpoint interface entity from a service, and likewise may not change such proprietary data, at least not without the consent of the first endpoint interface entity.

The splitting of transformation chain instances as described herein allows for a wide variety of scenarios. For instance, by only allowing output endpoints to be cloned in the portion transformation chain provided to the second endpoint interface entity, and retaining input and output endpoints with the first endpoint interface entity, the second endpoint interface entity may have a shared view on what the first endpoint interface entity is doing. Of course, the first endpoint interface entity may restrict which output endpoints are provided in the portion transformation chain, and thus such view sharing can even be restricted. Furthermore, collaborative and co-use scenarios are enabled by dividing input endpoints between the first and second endpoint interface entities. Several instances and versions of a portion transformation chain may be split off of the main transformation chain to allow such scenarios across more than two endpoint interface entities. Each split may have an associated proxy service that maintains proper information separation and functioning of the transformation chain.

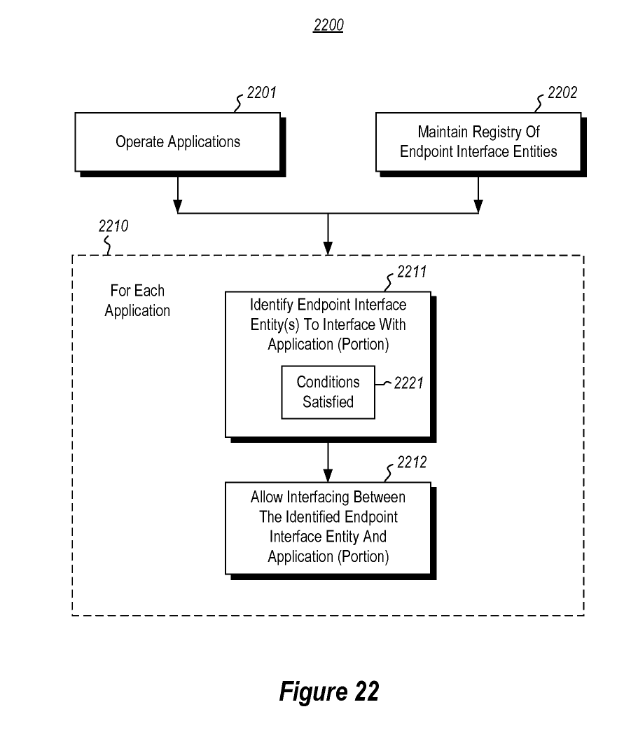

FIG. 22 illustrates a flowchart of a method 2200 for sharing an application in response to user input or other environmental event(s) at a first endpoint interface entity. The method is performed in the context of there being multiple applications operating (act 2201). For instance, in FIG. 14, there are multiple applications in the form of transformation chains operating within the universal canvas 1410. Furthermore, a registry of multiple endpoint interface entities is kept (act 2202). In FIG. 14, for example, this registry may be maintained by the endpoint interface entity registry module 1435. Recall that an endpoint interface entity may be a hardware entity and perhaps include associated user criteria defining a user status with respect to that hardware entity. Perhaps a single user may satisfy the user criteria with respect to multiple of the registered endpoint interface entities

For each of the applications, the content of box 2210 is performed. Specifically, at least one endpoint interface entity selected from the endpoint interface registry is identified (act 2211) as to interface with the application (or a portion thereof). This selection may include determining that the identified endpoint interface entity is credentialed to interface (or correspond) with the application (or the portion thereof). As part of this identification, it is determined that the environmental events) (if any) are satisfied with respect to the endpoint interface entity (act 2221). For instance, in FIG. 14, this identification may be made by the endpoint matching module 1437.

The identified endpoint interface entity is then allowed (act 2212) to interface with the application (or the portion thereof). In other words, within the scope of the application (or the portion thereof), the identified endpoint interface entity is permitted to interface with the corresponding application endpoints within that scope. In the case of a split application, in which different endpoint interface entities are to interface with different portions of the application, the delegation module 1439 operates as described above.

In the event that there are multiple endpoint interface entities that are available for a given application, the identification of an appropriate endpoint interface entity (act 2211) might also include determining that 1) an output endpoint for rendering at the hardware entity of the identified endpoint interface entity is efficiently perceivable to at least one (a plurality of) user that satisfies(y) the user criteria of the identified endpoint interface entity, or has some specific characteristic helpful or required to complete a portion of a user's task intent or delivery the appropriate action in response to some implicit event in the environment, and 2) does not conflict with at least one other output endpoint rendered at the hardware entity so as to adversely affect perception of at least one user that satisfies the user criteria. Similarly, the identification of an appropriate endpoint interface entity (act 2211) might also include determining that 1) an input endpoint for inputting at the hardware entity of the identified endpoint interface entity is capable of receiving input from at least one (a plurality of) active endpoint interface entities, or has some specific characteristic helpful or required to complete a portion of a user's task intent or delivery the appropriate action in response to some implicit event in the environment; and 2) an input endpoint for inputting at the hardware entity of the identified endpoint interface entity does not conflict with at least one other input endpoint rendered at the hardware entity so as to adversely affect ability to input of at least one user that interfaces with another endpoint interface entity. Through these determinations with respect to all input and output endpoints of the application, an appropriate distribution of interfacing may be determined.

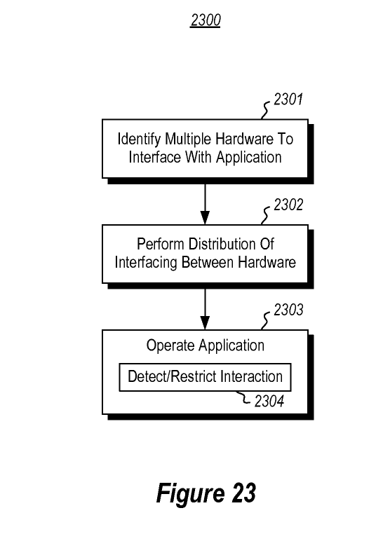

FIG. 23 illustrates a flowchart of a method 2300 for distributed interfacing with an application across a plurality of hardware entities. The method 2300 is an example of the act 2212 of FIG. 22 in the context of there being multiple endpoint interface entities that interface with a particular application. The method includes identifying that multiple hardware entities are available to interface with an application having multiple endpoints (act 2301). The method 2300 then includes performing of distribution of assignments (act 2302) of the hardware entities to interact with the endpoints. This assignment includes assigning which application endpoints each hardware entity may interface with. This assignment may be rules-based.

When the application is thereafter operated (act 2303), various interaction is performed at the endpoints. The presentation module 1438 tailors the interaction (act 2304) of the hardware entities with the endpoints by, for each endpoint, restricting the interaction capability of the endpoint perhaps according to the input and output hardware capabilities of the hardware entities. For instance, if an object is to be displayed on a large display that has no touch input, a prompt to “touch here” to perform some function may be removed, whereas if the object is being displayed on a touch screen, that prompt may be present. If information is being displayed via a particular output endpoint on a high fidelity display, perhaps more detail may be displayed on the high fidelity display as compared to, for instance, a watch having a smaller display. Thus, the interaction capability of an endpoint may be restricted. In other words, the input to an endpoint may be restricted according to capabilities of the hardware entity, and output from an endpoint may be restricted according to capabilities of the hardware entity.

Furthermore, restrictions may be made depending on compliance with the user criteria associated with a hardware entity. For instance, if most users are further away from the display, less detail might be displayed in favor of enlargement of visualizations. The rules for determining how to restrict an endpoint may be based on at least in part on 1) the interaction capabilities of the hardware entities, 2) anticipated interference in the capabilities of the hardware entities 3) a position of one or more users with respect to at least one or more of the hardware entities; and 4) a control of one or more users with respect to one or more of the hardware entities.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method for rendering information on at least one output device of a computing system, the method comprising:
an act of rendering a shareable set of information on an first output device, the shareable set of information being shareable in that one or more application portions that generated the shareable set of information may be extracted and operated for rendering of the shareable set of information at a second device; and
an act of outputting an emphasis that the shareable set of information is shareable so as to communicate to a user a technical readiness to receive and implement an instruction to share the shareable set of information to the second device.

2. The method in accordance with claim 1, the shareable set of information being a first set of information, the method further comprising:
an act of rendering a second set of information on the first output device, the second set of information not being shareable with the second output device,
the act of outputting being made in such a way as to communicate to the user that the second set of information is not shareable.

3. The method in accordance with claim 2, the act of rendering the first shareable set of information and the second non-shareable set of information being performed concurrently on the first output device.

4. The method in accordance with claim 1, the output device being a display, the act of rendering comprising an act of displaying the shareable set of information.

5. The method in accordance with claim 4, the act of outputting an emphasis occurring in response to user selection input associated with the shareable set of information being received.

6. The method in accordance with claim 5, the user selection input comprising a substantial circling of the displayed shareable set of information.

7. The method in accordance with claim 6, the user selection input comprising a crossing out gesture of a portion of the display substantially not displaying the shareable set of information.

8. The method in accordance with claim 4, the act of outputting an emphasis comprising an act of visually emphasizing the shareable set of information on the display.

9. The method in accordance with claim 8, the act of visually emphasizing the shareable set of information comprising an act of altering a color of at least a portion of the shareable set of information, or an object associated with the shareable set of information, in a manner that is different than would be the color if the shareable set of information were not shareable.

10. The method in accordance with claim 8, the act of visually emphasizing the shareable set of information comprising an act of altering a grouping of at least a portion of the shareable set of information in a manner that is different than would be the grouping if the shareable set of information were not shareable.

11. The method in accordance with claim 8, the act of visually emphasizing the shareable set of information comprising an act of altering a positioning of at least a portion of the shareable set of information in a manner that is different than would be the positioning if the shareable set of information were not shareable.

12. The method in accordance with claim 8, the act of visually emphasizing the shareable set of information comprising an act of altering a focus of at least a portion of the shareable set of information in a manner that is different than would be the focus if the shareable set of information were not shareable.

13. The method in accordance with claim 8, the act of visually emphasizing the shareable set of information comprising an act of altering a layering of at least a portion of the shareable set of information in a manner that is different than would be the layering if the shareable set of information were not shareable.

14. The method in accordance with claim 1, the act of outputting an emphasis being performed by the first device.

15. The method in accordance with claim 1, the act of outputting an emphasis occurring in response to user selection input associated with the shareable set of information being received.

16. The method in accordance with claim 1, the act of outputting an emphasis being in a same sensory form as the act of rendering the shareable set of information.

17. The method in accordance with claim 1, the act of outputting an emphasis being performed using a different sensory form as the act of rendering the shareable send of information.

18. The method in accordance with claim 1, further comprising:
an act of detecting a portion selection user interaction that is indicative of selection of the shareable set of information; and
in response to the act of detecting, an act of causing the shareable set of information to be extracted and sent to the second output device.

19. A system comprising:
one or more processors;
one or more computer-readable storage media having thereon computer-executable instructions that are structured such that, when executed by the one or more processors, and configured to cause the system to perform the following:
an act of identifying that a shareable set of information is being rendered on a first output device, the shareable set of information being shareable in that one or more application portions that generated the shareable set of information may be extracted and operated for rendering of the shareable set of information at a second device; and
an act of instruction that a user of the first output device be notified that the shareable set of information is shareable.

20. A computer program product comprising one or more computer-readable storage media having thereon computer-executable instructions that are structured such that, when executed by one or more processors of a system, cause the system to perform the following:
an act of identifying that a shareable set of information is being rendered on an first output device, an act of rendering a shareable set of information on an first output device, the shareable set of information being shareable in that one or more application portions that generated the shareable set of information may be extracted and operated for rendering of the shareable set of information at a second device; and
an act of instruction that a user of the first output device be notified that the shareable set of information is shareable.
